(19) United States
(12) Patent Application Publication
(10) Pub. No.: US 2026/0298451 A1
(43) Pub. Date: Oct. 1, 2026

(54) LIGHTING APPARATUS

(71) Applicant: LEEDARSON LIGHTING CO.,LTD., Zhangzhou (CN)

(72) Inventors: Gwang HU, Zhangzhou (CN); Xiping LIN, Zhangzhou (CN); Huitang ZHANG, Zhangzhou (CN); Xiaobo CHEN, Zhangzhou (CN); Huiyung HUANG, Zhangzhou (CN)

(21) Appl. No.: 19/344,089

(22) Filed: Sep. 29, 2025

(30) Foreign Application Priority Data
Mar. 31, 2025 (CN) 202510397806.7
Jun. 25, 2025 (CN) 202510863830.5

(51) Int. Cl. F21V 21/04; F21S 8/02; F21V 17/00; F21V 17/06; F21V 17/16; F21Y 115/10

(52) U.S. Cl. CPC F21V 21/044; F21S 8/02; F21V 17/002; F21V 17/06; F21V 17/16; F21Y 2115/10

(57) ABSTRACT

A lighting apparatus includes a light source module, a plurality of resilient engagement structures and a surface rim. The light source module includes a housing that defines a height direction and contains at least one light source. Multiple resilient engagement structures are disposed on the housing. The multiple engagement structures are positioned at different locations along the height direction. The surface rim has a central opening and a surrounding rim. The central opening is configured for transmission of light from the at least one light source. The surrounding rim is configured to conceal an installation cavity. The surface rim is detachably secured to the housing by engagement with a selected one of the plurality of resilient engagement structures so as to configure the lighting apparatus with different structural or optical parameters.

### FIELD

The present invention is related to a lighting apparatus, and more particularly related to a lighting apparatus with a flexible configuration.

### BACKGROUND

Lighting devices play a fundamental role in human life, supporting both basic daily activities and modern social development. From the earliest use of fire to the widespread adoption of electric lamps, illumination has enabled extended productivity, improved safety, and enriched cultural experiences. The presence of reliable lighting is closely tied to quality of life and economic growth, and the demand for efficient lighting continues to expand worldwide.

In recent decades, technological advances have transformed how light is produced and delivered. While traditional incandescent and fluorescent sources provided adequate brightness, they were often associated with limitations such as high energy consumption, shorter service life, and maintenance challenges. These drawbacks created a need for new approaches that could maintain the benefits of illumination while reducing the negative impact on energy resources and the environment.

Light-emitting diode (LED) technology has emerged as one of the most effective solutions to these challenges. LEDs are capable of delivering high-quality light with substantially improved energy efficiency. They provide long operating lifetimes, reduced maintenance requirements, and a level of reliability that surpasses many earlier technologies. As a result, LEDs have become a central element of modern lighting strategies in residential, commercial, and industrial applications.

Beyond efficiency, LED devices offer design flexibility that traditional light sources could not achieve. Because of their compact size and solid-state nature, LEDs can be integrated into diverse forms and configurations. This enables manufacturers and designers to create products with improved aesthetics, reduced bulk, and novel functions that adapt to user needs in both interior and exterior environments.

The shift toward LED-based solutions has also supported global energy conservation goals. By reducing electricity demand, LED adoption contributes to lower greenhouse gas emissions and reduced operating costs. Governments, businesses, and consumers alike have recognized the value of LEDs in achieving sustainable development, and many regions have implemented policies or incentives that encourage widespread transition.

While the benefits of LED lighting are widely acknowledged, there remains a continuing demand for designs that further enhance performance and accessibility. Users seek not only energy efficiency but also greater adaptability, such as adjustable brightness, selectable color characteristics, and easier installation. These expectations challenge manufacturers to balance advanced technical capabilities with affordability and ease of use.

The evolution of lighting technologies also underscores the importance of reliability and safety. A well-designed LED device must provide stable operation under varied conditions, protecting users from potential hazards while maintaining consistent performance. Attention to design details that simplify assembly, ensure secure engagement, and minimize failure points can increase consumer trust and satisfaction.

As lighting has become integral to architectural design, personal comfort, and urban planning, aesthetic considerations are increasingly significant. Consumers are no longer content with purely functional devices; they expect lighting to contribute to atmosphere and style. The versatility of LEDs allows manufacturers to respond to these expectations, blending performance with visual appeal in ways that were previously unattainable.

The progression from traditional structures to LED technology highlights a trend toward multifunctional, modular systems. Instead of single-purpose fixtures, there is interest in lighting devices that can be reconfigured or adapted over time. This modularity supports sustainability by extending product life and reducing waste, while also giving users more control over how their lighting devices perform in different settings.

In conclusion, lighting devices are not only essential for everyday life but also a key component of broader societal advancement. LED technology provides a compelling path to replace traditional structures with more efficient, reliable, and flexible solutions. As people continue to seek more adaptable and cost-effective designs, it is always beneficial to pursue innovations that deliver energy savings, functional improvements, and user-centered flexibility.

### SUMMARY

In some embodiments, a lighting apparatus includes a light source module, a plurality of resilient engagement structures and a surface rim.

The light source module includes a housing that defines a height direction and contains at least one light source.

Multiple resilient engagement structures are disposed on the housing.

The multiple engagement structures are positioned at different locations along the height direction.

The surface rim has a central opening and a surrounding rim.

The central opening is configured for transmission of light from the at least one light source.

The surrounding rim is configured to conceal an installation cavity.

The surface rim is detachably secured to the housing by engagement with a selected one of the plurality of resilient engagement structures so as to configure the lighting apparatus with different structural or optical parameters.

In some embodiments, the resilient engagement structures comprise resilient snap-fit members.

In some embodiments, the resilient engagement structures are disposed at multiple levels along the height direction of the housing.

In some embodiments, the surface rim includes a resilient engagement portion configured to snap-fit with a corresponding one of the resilient engagement structures.

In some embodiments, engagement of the surface rim with different ones of the resilient engagement structures adjusts at least one of a protrusion depth of the surface rim relative to the housing, a visible aperture size of the central opening, and a concealment depth of the installation cavity.

In some embodiments, a plurality of different surface rims are interchangeably attachable to the housing at different ones of the resilient engagement structures.

In some embodiments, engagement of the surface rim with different ones of the resilient engagement structures causes a distance between the at least one light source and the central opening to vary.

In some embodiments, variation of the distance alters a beam spread angle of light emitted from the lighting apparatus.

In some embodiments, the surface rim engages a first one of the resilient engagement structures when the light source module is installed in a downward direction relative to the surface rim, and engages a second one of the resilient engagement structures when the light source module is installed in an upward direction relative to the surface rim.

In some embodiments, the lighting apparatus may also include a driver circuit electrically coupled to the at least one light source and disposed within the housing.

In some embodiments, the lighting apparatus may also include a driver box coupled to an upper cover of the light source module by a buckle engagement structure.

In some embodiments, the buckle engagement structure includes a groove formed in one of the driver box and the upper cover of the light source module and a resilient tab formed on the other, the resilient tab being configured to resiliently engage the groove.

In some embodiments, the buckle engagement structure includes two grooves and a tongue, with a first groove configured to cooperate with the tongue and a second groove configured to cooperate with the resilient tab.

In some embodiments, in a first configuration the tongue and the resilient tab are disposed on the driver box and the two grooves are disposed on the upper cover of the light source module, and in a second configuration the tongue and the resilient tab are disposed on the upper cover of the light source module and the two grooves are disposed on the driver box.

In some embodiments, the lighting apparatus may also include a plurality of sensing structures respectively associated with the resilient engagement structures.

Engagement of the surface rim with a selected one of the resilient engagement structures actuates a corresponding one of the sensing structures to generate a configuration signal indicative of a selected engagement position.

The driver circuit is configured to set an operating parameter of the lighting apparatus based on the configuration signal.

In some embodiments, a resilient member of the surface rim depresses the corresponding one of the sensing structures upon completion of snap-fit engagement to generate the configuration signal.

In some embodiments, when the configuration signal indicates incomplete engagement of the surface rim with the selected one of the resilient engagement structures, the driver circuit disables the at least one light source.

In some embodiments, the resilient engagement structures define a plurality of angular engagement positions at different rotational orientations and the sensing structures are arranged to distinguish the plurality of angular engagement positions.

The driver circuit is configured to set different optical parameters based on a detected rotational orientation.

In some embodiments, a plurality of fastening brackets are disposed on a side portion of the lighting apparatus.

Each fastening bracket is configured with a buckle engagement structure to detachably couple with the housing of the light source module.

In some embodiments, the light source module includes an LED module oriented to emit along the height direction and includes a cylindrical body and a flared horn-shaped extension surrounding the LED module.

### BRIEF DESCRIPTION OF DRAWINGS

FIG. 1 is an exploded view of a luminaire in some embodiments of the present application.

FIG. 1a is a structural schematic diagram of a downlight assembly provided in an embodiment of the present application.

FIG. 2 is a structural schematic diagram of the luminaire at one viewing angle when the housing in FIG. 1 is in a first assembly state.

FIG. 2a is an exploded structural schematic diagram of a downlight assembly provided in an embodiment of the present application.

FIG. 3 is a structural schematic diagram of the luminaire when the housing in FIG. 1 is in a second assembly state.

FIG. 3a is another structural schematic diagram of a downlight assembly provided in an embodiment of the present application.

FIG. 4 is a partial structural schematic diagram of the back housing module in FIG. 1.

FIG. 4a is another exploded structural schematic diagram of a downlight assembly provided in an embodiment of the present application.

FIG. 5 is a structural schematic diagram of the surface rim module in FIG. 1.

FIG. 5a is another sectional view of a downlight assembly provided in an embodiment of the present application.

FIG. 6 is a top view of the luminaire when the housing in FIG. 2 is in the first assembly state.

FIG. 6a is a structural schematic diagram of a driver assembly in a downlight assembly provided in an embodiment of the present application.

FIG. 7 is a sectional view along line A-A in FIG. 6.

FIG. 7a is a structural schematic diagram of a light source assembly in a downlight assembly provided in an embodiment of the present application.

FIG. 8 is an enlarged view of portion I in FIG. 7.

FIG. 8a is a structural schematic diagram of a surface rim assembly in a downlight assembly provided in an embodiment of the present application.

FIG. 9 is a front view of the luminaire when the housing in FIG. 2 is in the first assembly state.

FIG. 9a is a structural schematic diagram of the surface rim assembly cooperating with the mounting assembly in a downlight assembly provided in an embodiment of the present application.

FIG. 10 is an assembly process schematic diagram when the housing in FIG. 2 is in the first assembly state.

FIG. 11 is a three-dimensional sectional view at line A-A in FIG. 6 when the housing is in the first assembly state.

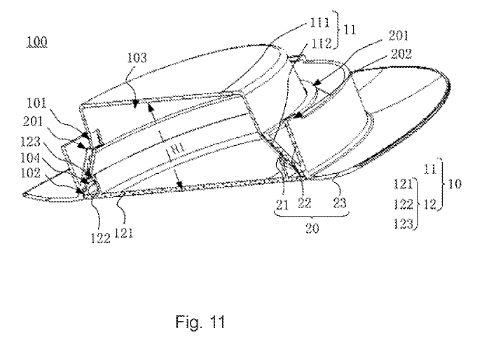

FIG. 12 is a light path diagram of the luminaire when the housing is in the first assembly state.

FIG. 13 is a front view of the luminaire when the housing in FIG. 3 is in the second assembly state.

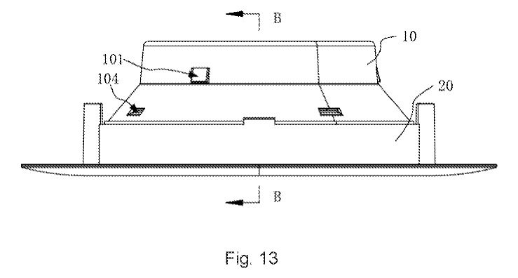

FIG. 14 is a sectional view along line B-B in FIG. 13.

FIG. 15 is an assembly process schematic diagram when the housing in FIG. 3 is in the second assembly state.

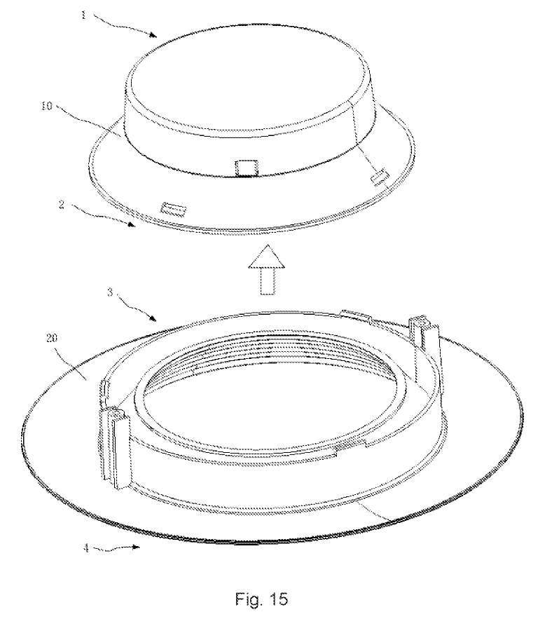

FIG. 16 is a three-dimensional sectional view at the same position as line A-A in FIG. 6 when the housing is in the second assembly state.

FIG. 17 is a light path diagram of the luminaire when the housing is in the second assembly state.

FIG. 18 illustrates another embodiment.

### DETAILED DESCRIPTION

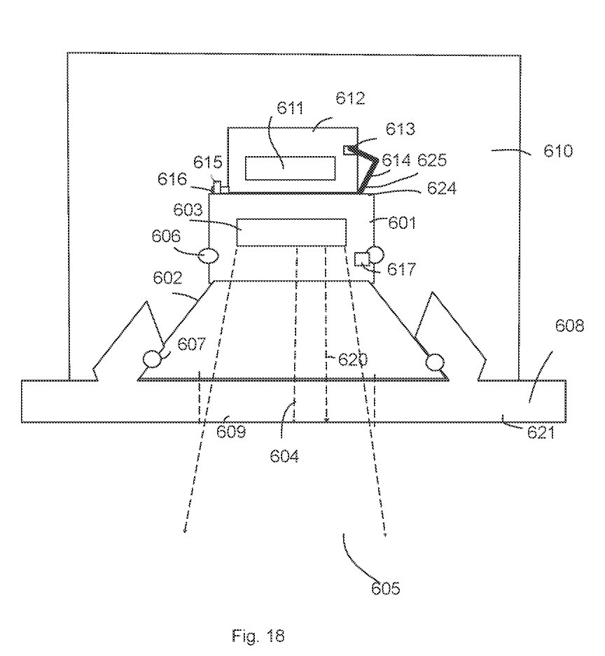

In FIG. 18, a lighting apparatus includes a light source module 601, a plurality of resilient engagement structures 606, 607 and a surface rim 608.

The light source module 601 includes a housing 602 that defines a height direction 620 and contains at least one light source 611.

Multiple resilient engagement structures 606, 607 are disposed on the housing 602.

The multiple engagement structures 606, 607 are positioned at different locations along the height direction 620.

The surface rim 608 has a central opening 609 and a surrounding rim 621.

The central opening 609 is configured for transmission of light from the at least one light source 611.

The surrounding rim 621 is configured to conceal an installation cavity 610.

The surface rim 608 is detachably secured to the housing 602 by engagement with a selected one of the plurality of resilient engagement structures 606, 607 so as to configure the lighting apparatus with different structural or optical parameters.

Different surface rims may be replaced easily because no screw is necessary in such embodiment. Buckles and similar structures can be easily operated to install or replace another surface rim at the same or different resilient engagement structures.

The resilient engagement structure is designed as a pair of components. One component is fixed to the housing 602 of the light source module 601 while the other component is fixed to the surface rim 608. Other drawings show more clear examples of such components.

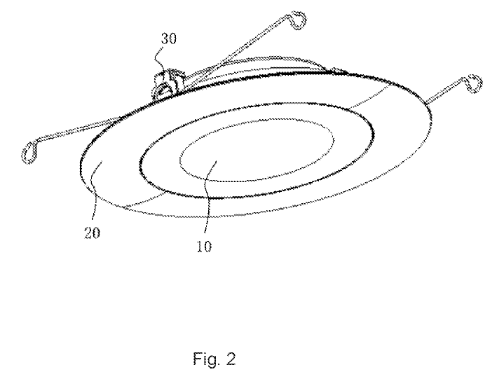

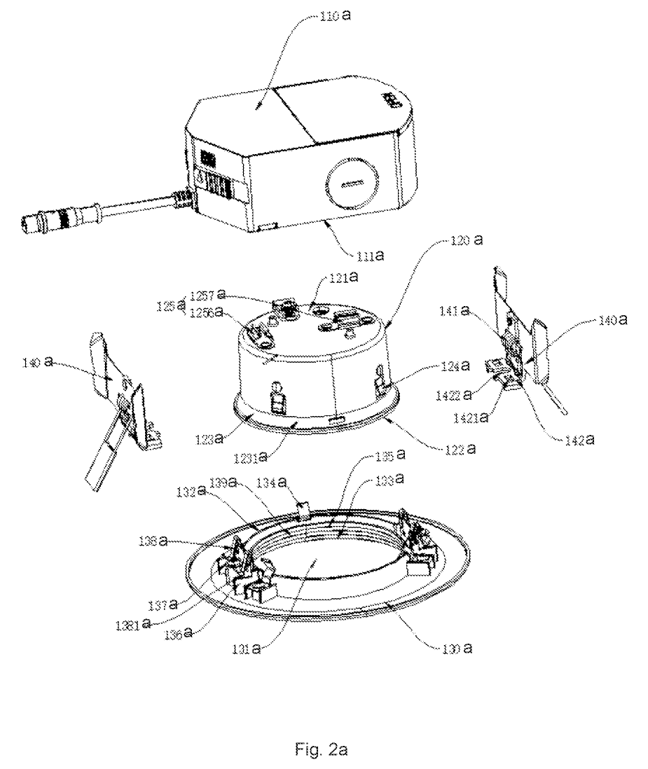

In some embodiments, the resilient engagement structures comprise resilient snap-fit members, e.g. the elastic clip 124 in FIG. 2a.

In some embodiments, the resilient engagement structures are disposed at multiple levels along the height direction of the housing.

In some embodiments, the surface rim includes a resilient engagement portion configured to snap-fit with a corresponding one of the resilient engagement structures.

In some embodiments, engagement of the surface rim with different ones of the resilient engagement structures adjusts at least one of a protrusion depth of the surface rim relative to the housing, a visible aperture size of the central opening, and a concealment depth of the installation cavity.

In some embodiments, a plurality of different surface rims are interchangeably attachable to the housing at different ones of the resilient engagement structures.

In some embodiments, engagement of the surface rim with different ones of the resilient engagement structures causes a distance between the at least one light source and the central opening to vary.

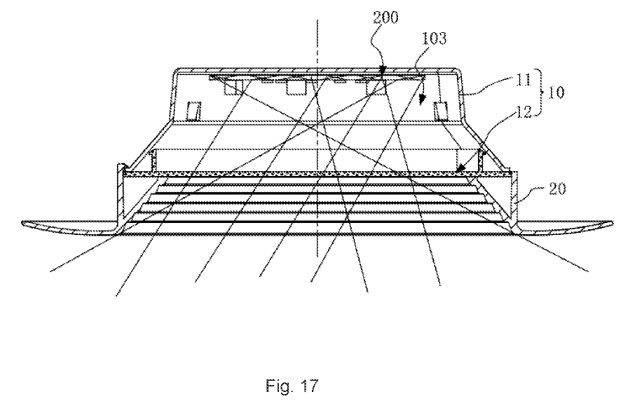

In some embodiments, variation of the distance alters a beam spread angle of light emitted from the lighting apparatus, e.g. FIG. 17 shows light spreading an angle and it will be changed while changing the distance between the light source to the opening of the surface rim.

In some embodiments, the surface rim engages a first one of the resilient engagement structures when the light source module is installed in a downward direction relative to the surface rim, and engages a second one of the resilient engagement structures when the light source module is installed in an upward direction relative to the surface rim.

In some embodiments, the lighting apparatus may also include a driver circuit 611 electrically coupled to the at least one light source and disposed within the housing. In the example of FIG. 18, the driver circuit 611 is placed in a driver box 612.

In some embodiments, the lighting apparatus may also include a driver box 612 coupled to an upper cover 624 of the light source module 601 by a buckle engagement structure 625.

In some embodiments, the buckle engagement structure 625 includes a groove 613 formed in one of the driver box 612 and the upper cover 624 of the light source module and a resilient tab 613 formed on the other, the resilient tab 614 being configured to resiliently engage the groove 613.

In some embodiments, the buckle engagement structure includes two grooves 615 and two tongues 616, with two grooves 615 configured to cooperate with the tongues 616.

In some embodiments, in a first configuration the tongue and the resilient tab are disposed on the driver box and the two grooves are disposed on the upper cover of the light source module, and in a second configuration the tongue and the resilient tab are disposed on the upper cover of the light source module and the two grooves are disposed on the driver box.

In some embodiments, the lighting apparatus may also include a plurality of sensing structures 617 respectively associated with the resilient engagement structures.

For example, the sensing structures may be a switch actuated when the resilient engagement structure like a protruding clip head pressing the sensing structure 617 while installation. The sensing structure 617 may be connected with a wire to the driver circuit 611 so that the driver circuit 611 knows what resilient engagement structure is used.

Engagement of the surface rim with a selected one of the resilient engagement structures actuates a corresponding one of the sensing structures to generate a configuration signal indicative of a selected engagement position.

The driver circuit is configured to set an operating parameter of the lighting apparatus based on the configuration signal.

In some embodiments, a resilient member of the surface rim depresses the corresponding one of the sensing structures upon completion of snap-fit engagement to generate the configuration signal.

In some embodiments, when the configuration signal indicates incomplete engagement of the surface rim with the selected one of the resilient engagement structures, the driver circuit disables the at least one light source.

In some embodiments, the resilient engagement structures define a plurality of angular engagement positions at different rotational orientations and the sensing structures are arranged to distinguish the plurality of angular engagement positions.

The driver circuit is configured to set different optical parameters based on a detected rotational orientation.

In some embodiments, a plurality of fastening brackets are disposed on a side portion of the lighting apparatus.

Each fastening bracket is configured with a buckle engagement structure to detachably couple with the housing of the light source module.

In some embodiments, the light source module includes an LED module oriented to emit along the height direction and includes a cylindrical body and a flared horn-shaped extension surrounding the LED module.

In some embodiments, a lighting apparatus includes a light source module that has a housing defining a height direction. The housing may be formed from metal, plastic, or composite materials, and serves both as a structural enclosure and as a heat-dissipation element. The light source module contains at least one light source, which may be a single LED chip, an array of LEDs, or another solid-state emitter. The height direction provides a reference axis along which multiple other features can be arranged, enabling modular engagement with external parts.

In some embodiments, the housing of the light source module is equipped with a plurality of resilient engagement structures. These resilient engagement structures may be located at different positions along the height direction, for example near the top, middle, and bottom of the housing wall. By distributing these structures at different heights, the apparatus allows for secure and flexible attachment of additional components, such as rims or driver housings, without requiring separate fasteners.

In some embodiments, the resilient engagement structures comprise resilient snap-fit members. Such members may include flexible tabs, hooks, tongues, or spring arms that deform elastically when pressed into a corresponding slot or groove. When released, the resilient member returns toward its original shape, creating a secure interlock that resists unintended disengagement. This snap-fit arrangement reduces assembly time and minimizes the need for screws or adhesives.

In some embodiments, a surface rim is provided with a resilient engagement portion configured to snap-fit with a corresponding resilient engagement structure. The surface rim may include spring fingers or a resilient ring that expands slightly when pressed over the housing and then contracts into the engagement position. This design enables the rim to be removed or replaced without tools, allowing users to customize the appearance or performance of the lighting apparatus.

In some embodiments, the surface rim includes a central opening aligned with the light source to allow light to pass through. The rim further includes a surrounding flange configured to conceal an installation cavity or recess into which the light source module is mounted. Engagement of the rim with different ones of the resilient engagement structures adjusts the protrusion depth of the rim relative to the housing, changes the size of the visible aperture, and alters the depth of concealment of the installation cavity. These adjustments allow the same light source module to be configured for various architectural or decorative requirements.

In some embodiments, multiple surface rims of different designs are interchangeably attachable to the same light source module. A manufacturer may offer a selection of rims with different contours, surface finishes, or colors. Each rim can be secured to the housing using the same resilient engagement structures, enabling end users or installers to adapt the lighting fixture for different environments without replacing the core light source module.

In some embodiments, engagement of the surface rim at different heights changes the distance between the light source and the rim’s central opening. A rim attached at a lower engagement point will sit closer to the light source, while a rim attached at a higher engagement point will sit farther away. This change in relative positioning can be used to control the optical characteristics of the emitted light.

In some embodiments, the variation in the distance between the light source and the rim’s central opening alters the beam spread angle of the light output. When the light source is closer to the rim, the beam may be narrower and more focused, while greater distance may produce a wider and softer spread. This allows a single lighting apparatus to serve both accent lighting applications and general illumination needs, depending on the selected rim configuration.

In some embodiments, the surface rim engages a first resilient engagement structure when the light source module is installed downward into the rim, and engages a second resilient engagement structure when the module is installed upward into the rim. This arrangement enables the same rim to be secured in two different positions depending on assembly direction, offering installers more flexibility and reducing the number of distinct parts required.

In some embodiments, the lighting apparatus further includes a driver circuit that is electrically coupled to the light source and disposed within the housing. The driver circuit may convert AC mains voltage to a stable DC output suitable for driving the LEDs, and may also provide additional features such as dimming control, thermal management, or communication with external controllers. Locating the driver circuit within the housing simplifies the overall assembly and reduces wiring complexity, while still allowing modular attachment of additional enclosures or accessories.

In some embodiments, a driver box is provided to house all or part of the driver circuit and is detachably coupled to an upper cover of the light source module. The driver box may be shaped to align with the cylindrical housing of the module and may include provisions for heat dissipation, cable entry, and mounting. The detachable arrangement allows the driver box to be replaced or upgraded independently of the light source module, which can simplify maintenance and reduce costs.

In some embodiments, the driver box is secured to the upper cover of the light source module by a buckle engagement structure. The buckle engagement structure may use complementary parts on the driver box and the module cover, allowing them to be snapped together or pried apart without the use of tools. This buckle structure ensures that electrical connections between the driver and the light source remain secure while also providing a degree of vibration resistance.

In some embodiments, the buckle engagement structure includes a groove formed on one of the driver box and the upper cover of the light source module, and a resilient tab formed on the other. During assembly, the resilient tab flexes into the groove and then returns to its resting position to lock the two parts together. The groove and tab can be dimensioned to provide a secure but releasable fit, balancing ease of assembly with long-term reliability.

In some embodiments, the buckle engagement structure includes two grooves and a tongue. A first groove is configured to receive the tongue, while a second groove is configured to receive a resilient tab. This arrangement distributes mechanical stress across multiple engagement points and provides redundancy, ensuring that the driver box remains securely attached even if one engagement point loosens over time.

In some embodiments, alternative configurations of the buckle engagement structure may be used. In a first configuration, the tongue and resilient tab are disposed on the driver box while the two grooves are disposed on the upper cover of the light source module. In a second configuration, the positions are reversed, with the tongue and resilient tab formed on the upper cover and the grooves formed on the driver box. These variations allow manufacturers flexibility in design and tooling, while achieving the same functional result.

In some embodiments, the lighting apparatus further comprises a plurality of sensing structures associated with the resilient engagement structures. When the surface rim engages a particular engagement structure, the corresponding sensing structure is actuated to generate a configuration signal. The driver circuit may then interpret this signal to automatically adjust operational parameters, such as brightness level, beam profile, or color setting. This arrangement reduces the need for manual adjustments and enables smart adaptation of the lighting apparatus.

In some embodiments, the surface rim includes a resilient member that depresses the sensing structure upon full engagement. This mechanical action ensures that the configuration signal is only generated when the snap-fit engagement is complete, providing confirmation of correct assembly. Such feedback mechanisms improve user safety and reliability, ensuring that the lighting apparatus does not operate when components are partially engaged.

In some embodiments, if the configuration signal indicates incomplete engagement of the surface rim with the selected resilient engagement structure, the driver circuit disables the light source. This safety measure prevents electrical operation under unsafe mechanical conditions, reducing the risk of heat buildup, arcing, or accidental detachment of components. The automatic disabling function can also alert installers to re-check the assembly before energizing the fixture.

In some embodiments, the resilient engagement structures define multiple angular positions, allowing the surface rim to be rotated to different orientations during installation. The sensing structures can distinguish between these orientations and send signals that prompt the driver circuit to adjust optical parameters accordingly. For example, a rim rotated into one angular position might cause the fixture to output a warmer color temperature, while another position could correspond to cooler illumination. This provides users with a simple and intuitive way to configure light output without complex controls.

In some embodiments, the lighting apparatus includes fastening brackets disposed on a side portion of the housing. Each fastening bracket incorporates a buckle engagement structure that detachably couples with the housing of the light source module. These brackets may be used to mount the lighting apparatus securely within an installation cavity, to attach decorative accessories, or to connect multiple modules together in an array. In certain designs, the brackets may also provide additional stability when the apparatus is subject to vibration or external forces.

In some embodiments, the light source module includes an LED module oriented to emit along the height direction. The module may have a cylindrical body that provides structural integrity and thermal conduction, as well as a flared horn-shaped extension surrounding the LED module. This horn-shaped extension serves to guide and distribute emitted light, reduce glare, and create a more uniform output. Variations of the horn extension may be tailored to specific beam angles, lumen outputs, or design aesthetics, supporting flexible adaptation across different lighting applications.

In some embodiments, the resilient engagement structures are positioned in a way that allows the light source module to be assembled with the surface rim in multiple orientations. Because the snap-fit connection is simple and requires no tools, an installer can rotate the light source module by 180 degrees and re-engage it, thereby selecting a different operational configuration without additional wiring or components.

In some embodiments, two resilient engagement structures are disposed on opposite sides of the housing. When the surface rim is connected in a first orientation, the lighting apparatus may correspond to a first color temperature setting. When the light source module is rotated by 180 degrees and re-engaged with the opposite resilient engagement structure, the apparatus may correspond to a second color temperature setting. This arrangement provides a straightforward way to achieve selectable output characteristics.

In some embodiments, the driver circuit is configured to detect which resilient engagement structure is engaged, and to adjust optical output accordingly. Detection can be accomplished mechanically, by using a tab on the rim that presses a switch or sensor in one orientation but not the other. Alternatively, detection can be accomplished electronically, by measuring circuit continuity or the status of embedded micro-sensors that respond to the engaged position.

In some embodiments, the use of rotational engagement provides intuitive control for installers and users. Instead of interacting with separate switches or software, the desired light parameter can be selected simply by rotating the module and snapping it into place. This reduces complexity, enhances usability, and minimizes the risk of misconfiguration in environments where reliable lighting performance is critical.

In some embodiments, the surface rim may incorporate structural cues, such as detents or keyed features, to ensure that 180-degree rotation produces stable and repeatable alignment. These features help guide the installer during assembly and prevent misalignment that could affect both aesthetics and safety. By ensuring repeatable engagement, the apparatus can reliably link each orientation to a distinct driver setting.

In some embodiments, more than two resilient engagement structures may be provided around the circumference of the housing, allowing multiple rotational positions beyond a single 180-degree switch. For example, four engagement points spaced at 90-degree intervals could correspond to four different light settings, such as different correlated color temperatures, lumen outputs, or dimming levels. This modular approach makes the lighting apparatus highly adaptable while maintaining low manufacturing complexity.

In some embodiments, the sensing structures associated with the resilient engagement structures are capable of distinguishing between opposite engagement positions. A mechanical plunger switch, a Hall-effect sensor with a magnet, or an optical sensor aligned with a reflective tab can be incorporated into the design. The driver circuit then interprets the sensor output to assign the correct operational mode for each rotational orientation.

In some embodiments, the ability to rotate and re-engage the light source module enhances serviceability and customization. An end user or technician can quickly change lighting parameters without replacing the rim, the light source, or the driver. This reduces waste, lowers long-term cost of ownership, and allows one base design to support a wider range of applications and user preferences.

In some embodiments, safety features are incorporated to ensure that the apparatus only activates once full engagement at the rotated position is confirmed. The same configuration signal used for axial engagement can be extended to confirm proper rotational alignment. If the light source module is partially engaged or rotated into an intermediate, unsupported position, the driver circuit may disable output until correct engagement is detected.

In some embodiments, this rotation-based configuration technique illustrates the flexibility of resilient engagement structures not only for mechanical assembly but also as an input method for operational control. By combining mechanical engagement with electronic sensing, the lighting apparatus integrates physical installation steps with functional customization. This synergy allows lighting systems to achieve adaptable, low-cost, and user-friendly designs while maintaining reliable performance.

During interior decoration, users typically select lighting apparatuses such as downlights based on the overall style of the room, with the most important consideration being that the appearance of the housing of the lighting apparatus matches the decoration style. Conventional downlight housings generally present a flat surface rim or a stepped surface rim at the light-emitting side. Users may therefore select a specific housing appearance according to different decoration needs.

In related technology, the housing of such lighting apparatuses is relatively limited in appearance, restricting application scenarios. At the same time, when the housing is damaged, the entire unit must often be replaced, resulting in higher repair and replacement costs.

To address the above problems, embodiments of the present application provide a lighting apparatus and a corresponding housing. The lighting apparatus includes a housing 100 and a light source module 200, with the light source module 200 being disposed within the housing 100.

The light source module 200 is used to provide illumination, and users may select different types of light sources according to need, which may include but are not limited to LED sources.

The lighting apparatus may be, but is not limited to, a downlight. In the following description, the housing 100 of the lighting apparatus is illustrated with reference to the housing of a downlight as an example.

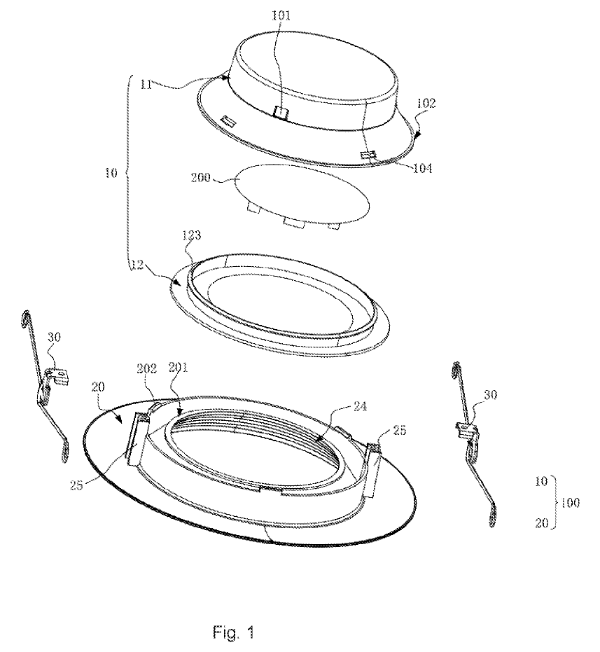

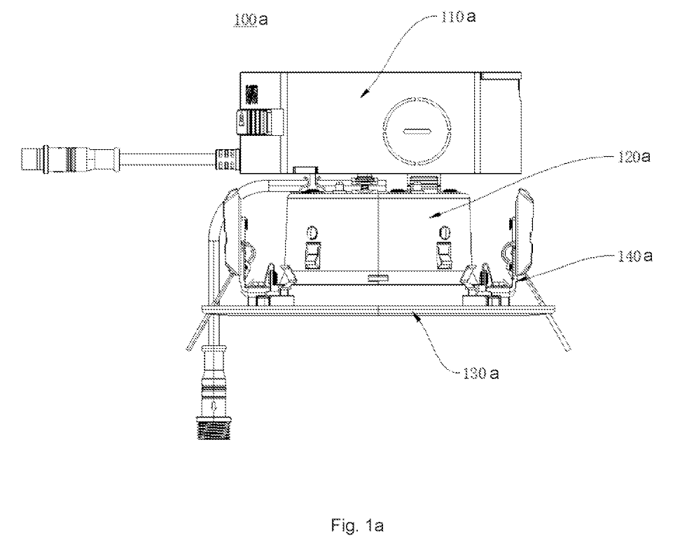

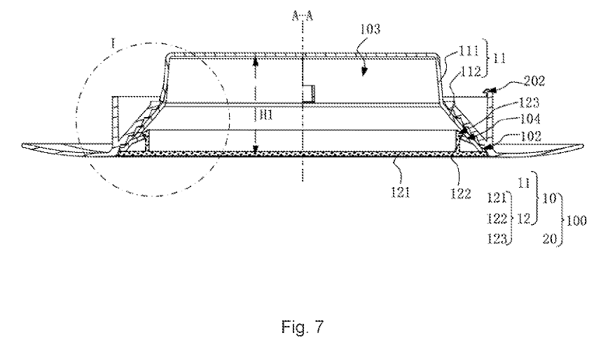

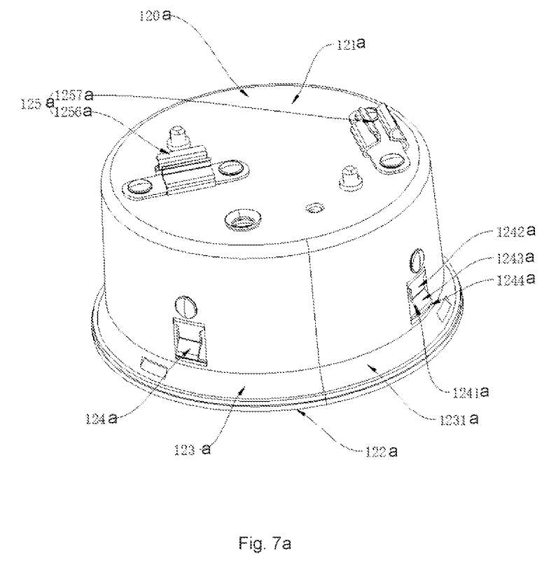

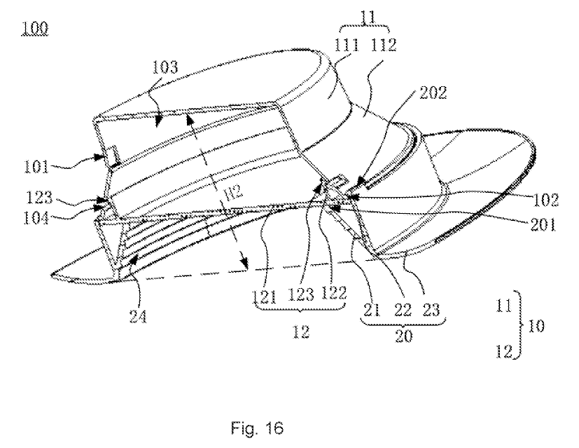

As shown in FIGS. 1–5,7, and 12-17, the housing 100 of the lighting apparatus has a first assembly state and a second assembly state. The housing 100 includes a back housing module 10 and a surface rim module 20. The back housing module 10 defines a receiving cavity 103 for installation of the light source module 200. An outer surface of the back housing module 10 is provided with a first mounting portion 101 and a second mounting portion 102. The back housing module 10 further includes a back-light end 1 and a first light-emitting end 2. The surface rim module 20 includes a central opening 203 into which the back housing module 10 extends. The central opening 203 includes a light-entry end 3 and a second light-emitting end 4. The surface rim module 20 further includes a third mounting portion 201 and a fourth mounting portion 202. When the housing 100 is in the first position, the first mounting portion 101 is connected to the third mounting portion 201, the first light-emitting end 2 is positioned within the central opening 203, the first light-emitting end 2 is located adjacent to the second light-emitting end 4, and the distance between the end surface of the back-light end 1 and the end surface of the second light-emitting end 4 is a first distance H1 (see the arrow in FIG. 7). When the housing 100 is in the second position, the second mounting portion 102 is connected to the fourth mounting portion 202, the first light-emitting end 2 is aligned with the light-entry end 3, and the distance between the end surface of the back-light end 1 and the end surface of the second light-emitting end 4 is a second distance H2 (see the arrow in FIG. 16). The second distance H2 is greater than the first distance H1, such that the housing 100 exhibits a different appearance in the first and second assembly states.

The back housing module 10 serves the function of supporting and installing the light source module 200. Typically, the light source module 200 is disposed within the receiving cavity 103 of the back housing module 10. Specifically, the back housing module 10 includes a back housing 11 and a light-transmitting cover 12, with the back housing 11 and the light-transmitting cover 12 together defining the receiving cavity 103. During assembly of the back housing module 10, the light source module 200 is first fixed inside the back housing 11, after which the light-transmitting cover 12 is installed. Light emitted by the light source module 200 passes through the light-transmitting cover 12 to exit the back housing module 10.

The first mounting portion 101 and the third mounting portion 201 are configured to connect with each other, and the second mounting portion 102 and the fourth mounting portion 202 are configured to connect with each other, so that the surface rim module 20 and the back housing module 10 can be assembled together. This enables the housing 100 to assume different assembly states and thereby exhibit different appearances. With this modular design, the housing 100 may be assembled by first individually assembling the surface rim module 20 and the back housing module 10, and then combining the two modules. This arrangement not only simplifies the assembly process of the housing 100 but also allows for replacement of only the damaged module—whether the back housing module 10 or the surface rim module 20—without the need to replace the entire housing. Accordingly, maintenance costs are reduced.

Typically, the light source module 200 is positioned adjacent to the back-light end 1 of the back housing module 10. Regardless of whether the housing 100 is in the first assembly state or the second assembly state, the second light-emitting end 4 of the surface rim module 20 serves as the final light-emitting end of the housing 100. In installation, the back-light end 1 usually extends deepest into a wall cavity, while the second light-emitting end 4 abuts the wall surface to cover an installation hole for the lighting apparatus. In other words, the distance between the end surface of the back-light end 1 and the end surface of the second light-emitting end 4 defines the overall thickness of the housing 100. The thickness direction of the back housing module 10 corresponds to the axial direction of the housing 100.

As shown in FIGS. 2 and 7, when the housing 100 is in the first assembly state, a portion of the back housing module 10 near the first light-emitting end 2 is located within the central opening 203 of the surface rim module 20, and this portion is enclosed by the surface rim module 20. In this state, the end surface of the first light-emitting end 2 may be flush with the end surface of the second light-emitting end 4, such that the housing 100 presents a flat surface rim appearance, as shown in FIG. 2. Alternatively, when the housing 100 is in the first assembly state, the end surface of the first light-emitting end 2 may be recessed relative to the end surface of the second light-emitting end 4 by a predetermined distance, such that a portion of the wall surface of the central opening 203 near the second light-emitting end 4 is exposed.

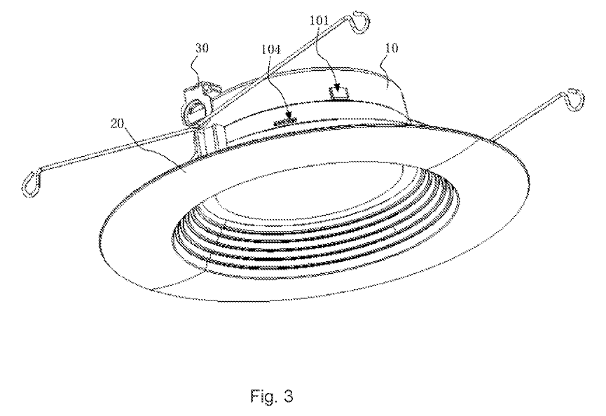

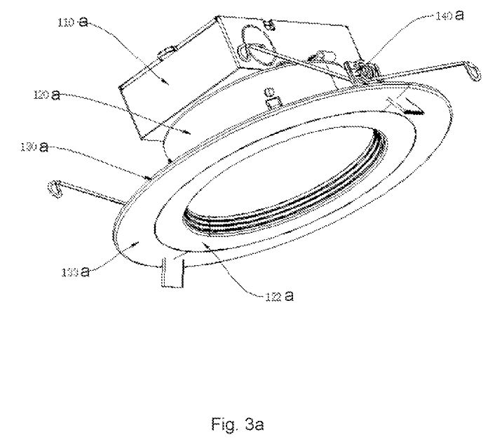

As shown in FIGS. 3, 14, and 16, when the housing 100 is in the second assembly state, the end surface of the first light-emitting end 2 abuts the end surface of the light-entry end 3 of the central opening 203. In this state, the entire wall surface of the central opening 203 is exposed, and the housing 100 presents a stepped surface rim appearance, as shown in FIG. 3. For aesthetic purposes, the wall of the central opening 203 may include a plurality of ribs 24 extending circumferentially around the surface rim module 20. The ribs 24 are arranged in a stepped configuration, such that in the second assembly state, the user can see the stepped rim appearance defined by the plurality of ribs 24. In the provided embodiments, the back housing module 10 includes a first mounting portion 101 and a second mounting portion 102 on its outer surface, and the surface rim module 20 includes a third mounting portion 201 and a fourth mounting portion 202. When the first mounting portion 101 is connected to the third mounting portion 201, the housing 100 is in the first assembly state, and the distance between the end surface of the back-light end 1 and the end surface of the second light-emitting end 4 is H1, defining a first overall thickness of the housing 100. When the second mounting portion 102 is connected to the fourth mounting portion 202, the housing 100 is in the second assembly state, and the distance between the end surface of the back-light end 1 and the end surface of the second light-emitting end 4 is H2. Since H2 is greater than H1, users may select different mounting connections to configure the housing 100 with different appearances. Furthermore, without changing the installation position of the light source module 200 within the receiving cavity 103, the distance between the light source module 200 and the end surface of the second light-emitting end 4 varies depending on the connection mode. This results in different appearances for the housing 100 in the first and second assembly states.

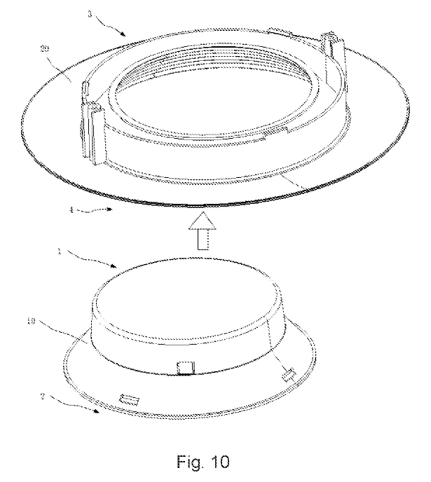

The assembly process of the housing 100 involving the back housing module 10 and the surface rim module 20 is as follows. The back housing module 10 is positioned below the surface rim module 20, meaning that the back-light end 1 of the back housing module 10 is located closer to the second light-emitting end 4 of the surface rim module 20, as shown in FIG. 10. The back housing module 10 is then assembled upward into the surface rim module 20, and this process is referred to as downward assembly.

Specifically, the transverse dimension of the back-light end 1 of the back housing module 10 in a section perpendicular to its axis must be smaller than the aperture of the second light-emitting end 4 of the central opening 203, so that the back-light end 1 can be inserted upward through the second light-emitting end 4. The aperture at the second light-emitting end 4 must also allow the first light-emitting end 2 of the back housing module 10 to enter, but the aperture at the light-entry end 3 of the central opening 203 must be smaller than the first light-emitting end 2, preventing it from passing through. As a result, when the back-light end 1 of the back housing module 10 is inserted upward from the second light-emitting end 4 into the central opening 203, the first light-emitting end 2 abuts against the light-entry end 3.

The downward assembly process of the housing 100 is therefore: the back-light end 1 of the back housing module 10 is inserted upward into the central opening 203 of the surface rim module 20 through the second light-emitting end 4 until the first mounting portion 101 of the back housing module 10 connects with the third mounting portion 201 of the surface rim module 20. At this stage, the first light-emitting end 2 abuts against the light-entry end 3, and the housing 100 is in the first assembly state. The appearance of the housing 100 after assembly in this state is shown in FIGS. 2 and 7.

In another case, the back housing module 10 may be positioned above the surface rim module 20, meaning that the first light-emitting end 2 of the back housing module 10 is located closer to the light-entry end 3 of the surface rim module 20, as shown in FIG. 16. In this arrangement, the back housing module 10 is assembled downward into the surface rim module 20, and this process is referred to as upward assembly.

Specifically, the transverse dimension of the first light-emitting end 2 of the back housing module 10 in a section perpendicular to its axis is greater than the diameter of the light-entry end 3 of the central opening 203, such that when the first light-emitting end 2 approaches the surface rim module 20 from above, the first light-emitting end 2 can only abut against the light-entry end 3 and cannot pass through the central opening 203.

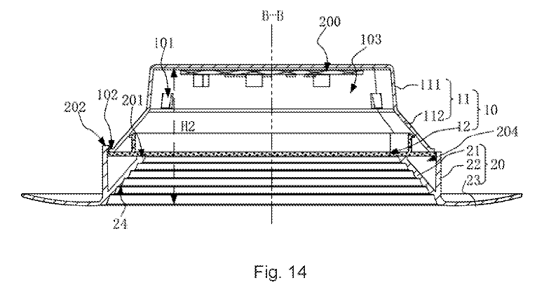

The upward assembly process of the housing 100 is therefore: the first light-emitting end 2 of the back housing module 10 is aligned with the central opening 203, and the surface rim module 20 is moved upward until the fourth mounting portion 202 of the surface rim module 20 connects with the second mounting portion 102 of the back housing module 10. At this stage, the first light-emitting end 2 abuts the light-entry end 3, and the housing 100 is in the second assembly state. The appearance of the housing 100 after assembly in this state is shown in FIGS. 3 and 14.

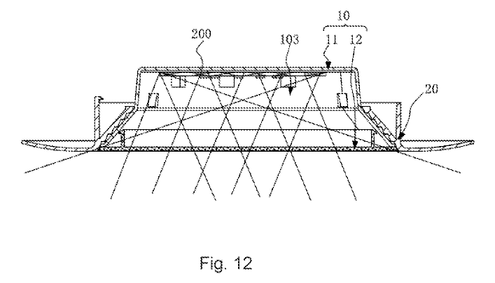

Without changing the installation position of the light source module 200 within the receiving cavity 103, the fact that H2 is greater than H1 allows users to select different connection methods to vary the distance between the light source module 200 and the end surface of the second light-emitting end 4 of the surface rim module 20. When the light source module 200 is mounted on the inner wall of the receiving cavity 103 adjacent to the back-light end 1, in the first assembly state the light emitted from the light source module 200 behaves as shown in FIG. 12, while in the second assembly state the light behaves as shown in FIG. 17. As a result, the light emission angle of the light source module 200 differs between the two assembly states, making the housing 100 adaptable to different lighting scene requirements.

Of course, if the position of the light source module 200 within the back housing module 10 is adjustable, users may also reposition the light source module 200 according to the assembly state of the housing 100 so that the distance between the light source module 200 and the end surface of the second light-emitting end 4 is equalized. In this case, the light emission angle of the light source module 200 can remain the same regardless of whether the housing 100 is in the first or second assembly state.

In summary, the housing 100 of the lighting apparatus described herein achieves the combined benefits of providing multiple appearance options, a wider range of application scenarios, and reduced maintenance costs.

As shown in FIGS. 1, 7, and 8, in some embodiments the back housing 11 is cylindrical in shape, having a closed end and an open end. The closed end defines the back-light end 1, and the open end defines the first light-emitting end 2. A light-transmitting cover 12 is disposed at the first light-emitting end 2 to form the receiving cavity 103. Along the thickness direction of the back housing module 10, the cross-sectional area at the back-light end 1 is smaller than the cross-sectional area at the first light-emitting end 2. The second mounting portion 102 is located adjacent to the first light-emitting end 2, while the first mounting portion 101 is located adjacent to the back-light end 1. Along the thickness direction of the back housing module 10, the fourth mounting portion 202 is positioned on one side of the third mounting portion 201, near the light-entry end 3.

The back housing 11 functions to support the light source module 200. Because the light source module 200 generates heat during illumination, the back housing 11 may be formed of metal materials such as aluminum to improve heat dissipation. Alternatively, the back housing 11 may also be formed of plastic or other lightweight materials to reduce the overall weight of the back housing module 10.

By positioning the second mounting portion 102 near the first light-emitting end 2 and the first mounting portion 101 near the back-light end 1, the first mounting portion 101 and the second mounting portion 102 are located on different planes of the back housing module 10 that are perpendicular to its thickness direction. This arrangement reduces interference between the first and second mounting portions during disassembly or assembly of the back housing module 10 and the surface rim module 20, thereby improving reliability of the back housing module 10. Furthermore, the configuration increases the difference between H2 and H1, expanding the range of light-emission angles available to the light source module 200.

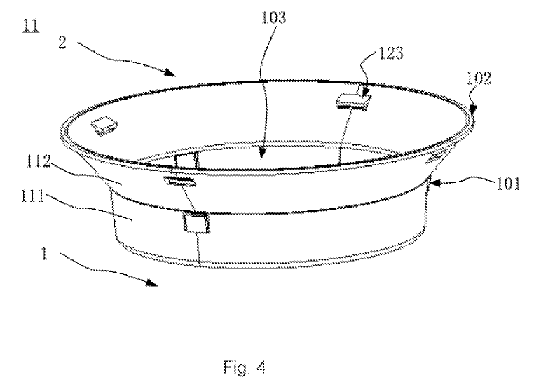

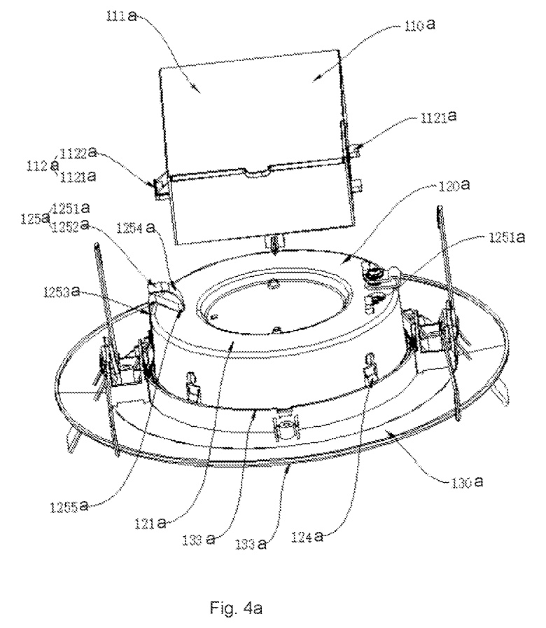

As shown in FIGS. 4 and 7, the back housing 11 includes a back-light section 111 and a light-emitting section 112. The back-light section 111 is cylindrical, while the light-emitting section 112 is flared in shape. The back-light section 111 connects to a narrower end of the light-emitting section 112. The first mounting portion 101 is positioned at the end of the back-light section 111 near the light-emitting section 112, while the second mounting portion 102 is disposed on the light-emitting section 112. Along the direction from the light-entry end 3 to the second light-emitting end 4 (the downward direction in FIG. 4), the diameter of the central opening 203 gradually increases. In other words, the central opening 203 has the smallest diameter near the light-entry end 3 and the largest diameter near the second light-emitting end 4. The maximum diameter of the central opening 203 is larger than the outer diameter of the back-light section 111, and the minimum diameter of the central opening 203 is smaller than the minimum diameter of the light-emitting section 112.

The flared form may also be referred to as a horn shape, having a large opening at one end and a small opening at the other. The smaller opening is near the back-light end 1, and the larger opening is near the second light-emitting end 4.

The light-emitting section 112 is flared, and the central opening 203 is correspondingly a flared circular opening. The inclination angle of the side wall of the light-emitting section 112 matches the inclination angle of the inner wall of the central opening 203. This means that when the housing 100 is in the first assembly state, the side wall of the light-emitting section 112 fits closely with the inner wall of the central opening 203. This not only maximizes the light output of the light source module 200 but also ensures secure connection between the back housing 11 and the surface rim module 20.

With this arrangement, the volume of the back housing 11 is reduced without affecting light emission from the light source module 200. As a result, the overall installation space required for the lighting apparatus is minimized, and the diameter of the central opening 203 is reduced. Thus, while meeting illumination requirements, the housing 100 also achieves a smaller overall volume.

During installation, the light source module 200 may be mounted not only at the inner wall near the back-light section 111, but also at different positions. For example, the light source module 200 may be mounted on the bottom wall of the back-light section 111, i.e., the inner wall of the receiving cavity 103 adjacent to the back-light end 1, as shown in FIG. 12. Alternatively, the light source module 200 may be mounted on the inner wall of the light-emitting section 112 so that emitted light passes directly out of the first light-emitting end 2. In another case, the light source module 200 may be mounted on the side wall of the back-light section 111, and a reflective element may be used to direct light toward and out of the first light-emitting end 2. These configurations are not limited in the present disclosure.

As shown in FIGS. 4, 5, 7, and 8, the small opening end of the central opening 203 is provided with a first flange, which serves as the third mounting portion 201. The third mounting portion 201 is annular, and its inner diameter is smaller than the minimum diameter of the central opening 203. The outer surface of the back-light section 111 of the back housing 11 is provided with an elastic arm, which serves as the first mounting portion 101. The free end of the first mounting portion 101 can move between a first position and a second position under an external force. When the free end of the first mounting portion 101 is in the first position, the back-light section 111 can pass through the central opening 203. When the free end of the first mounting portion 101 is in the second position, it abuts against the third mounting portion 201 to limit relative movement between the back housing 11 and the surface rim module 20.

The elastic arm is a protrusion that extends outward from the outer side wall of the back-light section 111 and can deform under force. The first mounting portion 101 has a fixed end connected to the back-light section 111 and a free end at the opposite side. In other words, the free end of the first mounting portion 101 can move toward or away from the outer side wall of the back-light section 111 under external force. When the free end of the first mounting portion 101 is in the first position, it is flush with or inside the outer side wall of the back-light section 111, allowing the back-light section 111 to pass through the central opening 203. After the back-light section 111 passes through, the free end of the first mounting portion 101 moves outward to the second position by its own resilience, thereby engaging the third mounting portion 201 and fixing the back housing 11 and the surface rim module 20 together. The first mounting portion 101 can also be pressed inward under force to return to the first position, thereby disengaging from the third mounting portion 201.

With this arrangement, users can assemble the surface rim module 20 and the back housing module 10 together without tools, improving assembly efficiency of the housing 100 and facilitating disassembly for users.

The third mounting portion 201 connected to the small opening of the central opening 203 may, in one embodiment, be annular, meaning that it fully surrounds the edge of the central opening 203 along its circumference. This not only enhances the structural strength of the connection between the third mounting portion 201 and the central opening 203 but also ensures that the design of the third mounting portion 201 is not limited by the number or positions of the first mounting portions 101.

To ensure firm connection of the surface rim module 20 and the back housing module 10 in the first assembly state, in one embodiment, multiple first mounting portions 101 may be arranged circumferentially around the back housing 11. Thus, when the surface rim module 20 and the back housing module 10 are assembled, multiple first mounting portions 101 engage with the third mounting portion 201, further enhancing connection strength.

In another embodiment, the third mounting portion 201 may only be provided at positions corresponding to the first mounting portions 101. In this case, the number of third mounting portions 201 may be less than or equal to the number of first mounting portions 101, as long as proper engagement is achieved.

It should be noted that the first mounting portion 101 may be integrally formed with the back housing 11. This not only improves strength and reliability of the back housing module 10 but also reduces assembly steps. When the back housing 11 is made of plastic, the back housing 11 and the first mounting portion 101 may be integrally formed by injection molding or fixed by adhesive bonding. When the back housing 11 is made of aluminum, the back housing 11 and the first mounting portion 101 may be integrally formed by die casting or fixed by welding.

Similarly, the third mounting portion 201 may be integrally formed with the surface rim module 20. This not only improves the strength and reliability of the surface rim module 20 but also reduces assembly steps. The surface rim module 20 may be made of plastic or metal. When made of plastic, the surface rim module 20 and the third mounting portion 201 may be integrally formed by injection molding or fixed by adhesive bonding. When made of metal, the surface rim module 20 and the third mounting portion 201 may be integrally formed by die casting or fixed by welding.

In addition to the flange-and-arm detachable structure, the first mounting portion 101 and the third mounting portion 201 may also be detachably connected by fasteners, such as screws, to allow easier disassembly and assembly of the surface rim module 20 and the back housing module 10.

If necessary, the first mounting portion 101 and the third mounting portion 201 may also be fixed by snap-fit or threaded connection. These alternatives are not specifically limited herein.

As shown in FIGS. 4, 5, 8, and 16, in some embodiments, the first light-emitting end 2 is provided with a second flange, which serves as the second mounting portion 102. The second mounting portion 102 is formed by extending outward from the edge of the first light-emitting end 2. The surface rim module 20 includes an inner ring and an outer ring. The inner ring defines the central opening 203, while the outer ring is connected to the outer side wall of the inner ring. The inner bore of the outer ring, at the end near the light-entry end 3, allows the first light-emitting end 2 to extend in. At the edge of the inner bore of the outer ring near the light-entry end 3, a hook is provided, which forms the fourth mounting portion 202.

The second mounting portion 102 may be formed integrally with the back housing 11 or separately as a distinct part.

Similarly, the fourth mounting portion 202 may be formed integrally with the outer ring or separately as a distinct part.

With this arrangement, when the light-emitting section 112 of the back housing 11 is inserted into the central region of the outer ring of the surface rim module 20, the second mounting portion 102 snap-fits with the fourth mounting portion 202. In this way, users can assemble the surface rim module 20 and the back housing module 10 together without tools, improving the assembly efficiency of the housing 100, while ensuring a secure connection between the surface rim module 20 and the back housing module 10. Users may also press the second mounting portion 102 or move the fourth mounting portion 202 outward to disengage them, thereby separating the surface rim module 20 from the back housing module 10, which facilitates disassembly.

It should be noted that, in addition to the flange-and-hook detachable structure described above, the second mounting portion 102 and the fourth mounting portion 202 may also be detachably connected by fasteners such as screws, allowing disassembly and reassembly of the surface rim module 20 and the back housing module 10.

If necessary, the second mounting portion 102 and the fourth mounting portion 202 may also be fixed by snap-fit or threaded connection. These alternatives are not specifically limited herein.

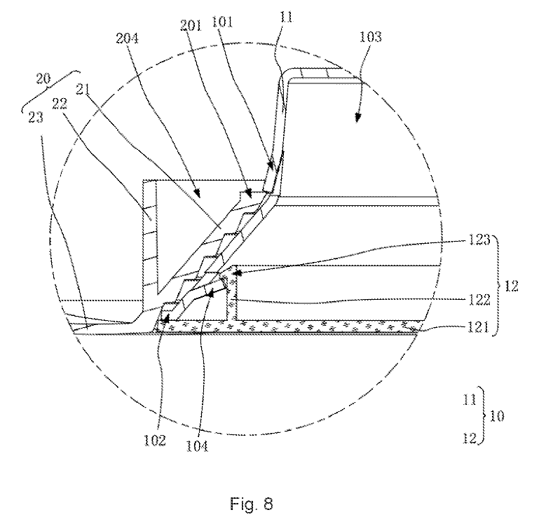

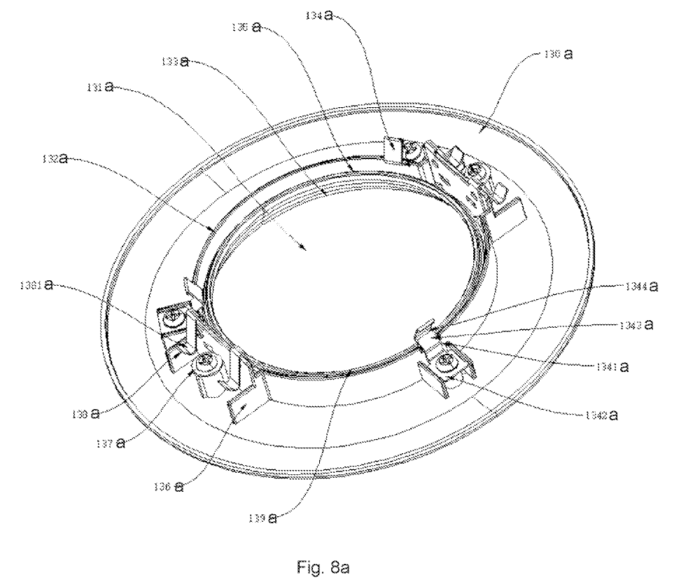

As shown in FIG. 8, in some embodiments, the outer ring is a hollow cylindrical structure, and the inner ring is a hollow frustoconical structure. The central through-hole of the inner ring defines the central opening 203. A cavity is formed between the inner ring and the outer ring. The large opening end of the inner ring serves as the light-entry end 3, and the small opening end serves as the second light-emitting end 4. The inner diameter of the outer ring is equal to the maximum outer diameter of the inner ring. The outer diameter of the inner ring gradually increases from the light-entry end 3 toward the second light-emitting end 4.

Because there is a cavity between the inner ring and the outer ring, the surface rim module 20 achieves both secure connection with the back housing module 10 and convenient assembly/disassembly, while also reducing the overall weight of the surface rim module 20.

It should be noted that, along the thickness direction of the back housing module 10, when the length of the inner ring is greater than the length of the light-emitting section 112, the end surface of the first light-emitting end 2 will be recessed inside the end surface of the second light-emitting end 4 when the housing 100 is in the first assembly state. In this case, part of the wall of the central opening 203 will be exposed. When the length of the inner ring is equal to the length of the light-emitting section 112, the end surface of the first light-emitting end 2 will be flush with the end surface of the second light-emitting end 4 in the first assembly state, resulting in a flat surface rim appearance.

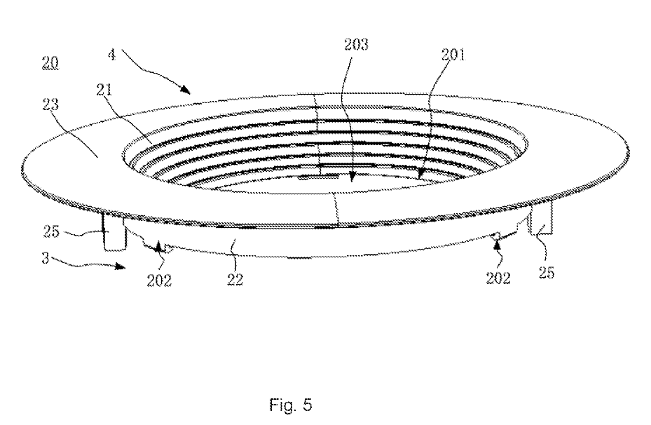

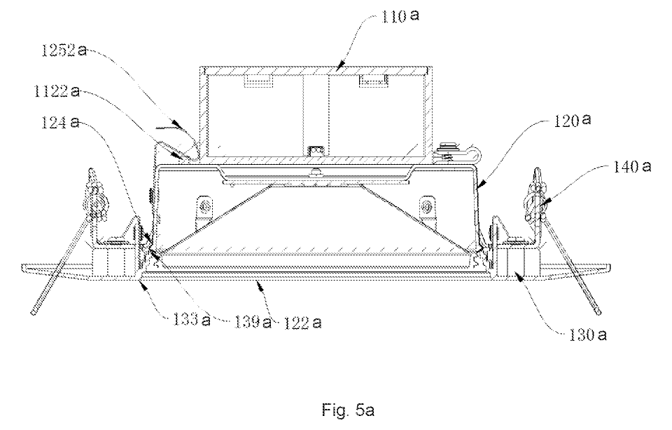

As shown in FIGS. 5, 7, and 8, a surface rim flange extends outward from the junction between the outer ring and the inner ring. The surface rim flange defines the surface of the second light-emitting end 4 and serves a decorative function.

The inner ring, outer ring, and surface rim flange may be integrally formed. This not only increases the structural strength of the surface rim module 20 and improves the reliability of the housing 100 but also simplifies the assembly process.

To ensure secure connection of the surface rim module 20 and the back housing module 10 in the second assembly state, in one embodiment, the second mounting portion 102 is annular, meaning that it extends fully around the edge of the first light-emitting end 2 of the light-emitting section 112. This arrangement enhances the connection strength between the second mounting portion 102 and the fourth mounting portion 202 and ensures that the connection is not limited by the number or positions of the fourth mounting portions 202.

To further enhance the connection strength between the surface rim module 20 and the back housing module 10 in the second assembly state, multiple fourth mounting portions 202 may be arranged circumferentially around the outer ring. In this way, multiple fourth mounting portions 202 engage with the second mounting portion 102 during assembly, further increasing connection reliability.

In another embodiment, the second mounting portion 102 may be provided only at positions corresponding to the fourth mounting portions 202. In this case, the number of second mounting portions 102 may be less than or equal to the number of fourth mounting portions 202, as long as engagement is achieved.

As shown in FIGS. 5 and 8, in some embodiments, the wall of the central opening 203 may not include ribs 24, or may include microstructures such as wave-like patterns. On one hand, this improves the aesthetic appearance of the lighting apparatus; on the other, the microstructures can function as reflective features to scatter light (diffuse reflection), resulting in more uniform light output.

To further improve light output efficiency, a reflective layer may be applied to the surface of the ribs 24 or the inner wall of the central opening 203, reflecting light emitted from the light source module 200 toward and out of the first light-emitting end 2. This enhances the luminous efficiency of the light source module 200.

The reflective layer may be a reflective coating, or the ribs 24 themselves may be made of reflective materials.

As shown in FIGS. 1 and 8, in some embodiments, the inner surface of the back housing module 10 is provided with a first snap portion 104, i.e., the inner side wall of the accommodating cavity 103 is provided with the first snap portion 104. The light-transmitting cover 12 is provided with a second snap portion 123. The first snap portion 104 and the second snap portion 123 are detachably connected. In this way, the light-transmitting cover 12 and the back housing 11 can be assembled and disassembled, improving assembly and maintenance efficiency.

As shown in FIG. 8, the light-transmitting cover 12 includes a light-transmitting plate 121 and a connecting tube 122. The connecting tube 122 is connected to one side of the light-transmitting plate 121. At the edge of the connecting tube 122 away from the light-transmitting plate 121, a second snap portion 123 is connected. The second snap portion 123 is a hook. Along the thickness direction of the back housing module 10, the first snap portion 104 is located between the first mounting portion 101 and the second mounting portion 102. The first snap portion 104 is a notch.

The light-transmitting plate 121 may be, but is not limited to, a diffusion plate.

Through this arrangement, the light-transmitting cover 12 and the back housing 11 can be detachably connected without tools, improving the installation and removal convenience of the light-transmitting cover 12, while also enhancing the strength of the light-transmitting cover 12 and contributing to the reliability of the back housing module 10.

It should be noted that, in addition to designing the first snap portion 104 and the second snap portion 123 as a hook and an elastic arm for snap-fit engagement, the first snap portion 104 and the second snap portion 123 may also be designed as a hook and notch structure for snap-fit engagement, or as a hook and elastic arm structure for snap-fit engagement.

To further improve the connection strength between the light-transmitting cover 12 and the back housing 11, the number of second snap portions 123 may be multiple, circumferentially arranged along the connecting tube 122.

For convenient installation of the housing 100 onto a target object, as shown in FIGS. 1 to 3, in some embodiments, the surface rim module 20 is provided with a connecting post 25 and an elastic member 30. The elastic member 30 is fixed to the surface rim module 20 via the connecting post 25 and is used to secure the surface rim module 20 onto the target object.

The target object may be, but is not limited to, a wall.

The connecting post 25 is provided with a mounting opening for installing the elastic member 30. The structure of the mounting opening is designed according to the structure of the elastic member 30, and is not specifically limited herein.

The elastic member 30 may be a spring or an elastic plate. The spring may be a V-shaped spring or a conventional coil spring.

Through this arrangement, the housing 100 of the lighting apparatus can be mounted onto a target object without tools, making installation convenient. Furthermore, after installation, the elastic member 30 provides elastic force to the target object, ensuring a firm connection between the two and reducing the risk of the lighting apparatus falling.

During interior decoration, users typically select a suitable lighting apparatus according to the room’s decoration style—for example, a downlight—with the foremost consideration being that the appearance of the housing matches the decoration style. In conventional downlights, the light-emitting face of the housing appearance commonly adopts a flat surface rim or a stepped surface rim. Users may choose a particular housing appearance to meet different decoration styles.

In the related art, the appearance of such a lighting apparatus housing is relatively singular, which limits application scenarios. At the same time, when the housing is damaged, the entire unit often needs to be replaced, resulting in high repair and replacement costs.

To solve the above technical problems, embodiments of the present application provide a downlight assembly. Refer to FIGS. 1a to 5a. FIG. 1a is a structural schematic diagram of a downlight assembly provided in an embodiment of the present application; FIG. 2a is an exploded structural schematic diagram of a downlight assembly provided in an embodiment of the present application; FIG. 3a is a structural schematic diagram of another downlight assembly provided in an embodiment of the present application; FIG. 4a is an exploded structural schematic diagram of another downlight assembly provided in an embodiment of the present application; and FIG. 5a is a sectional view of another downlight assembly provided in an embodiment of the present application. Among them, FIG. 1a shows the structure of the downlight assembly in a first connection state, and FIGS. 3a and 5a show the structure of the downlight assembly in a second connection state.

As shown in FIGS. 1a to 5a, an embodiment of the present application provides a downlight assembly 100a, which includes a first connection state and a second connection state. The downlight assembly 100a further includes: a driver assembly 110a, configured to drive a light source in a light source assembly 120a to emit light and having a first connection end 111a; the light source assembly 120a, having a second connection end 121a and a light-emitting end 122a, the second connection end 121a and the light-emitting end 122a being respectively located at two ends of the light source assembly 120a, and a first connection structure 123a and a second connection structure 124a being provided on a side wall of the light source assembly 120a; a surface rim assembly 130a, having a through hole 131a through which the light source assembly 120a can pass, the surface rim assembly 130a including a third connection end 132a and a second light-emitting end 133a, and a third connection structure 134a and a fourth connection structure 135a being provided on the surface rim assembly 130a; and a mounting assembly 140a, including a connection spring 141a and a connection lug 142a, the connection spring 141a being fixedly connected to the connection lug 142a, and the connection lug 142a being connected to the surface rim assembly 130a.

When the downlight assembly 100a is in the first connection state, the first connection end 111a of the driver assembly 110a is connected to the second connection end 121a of the light source assembly 120a, the light-emitting end 122a of the light source assembly 120a is connected to the third connection end 132a of the surface rim assembly 130a, and the first connection structure 123a is connected to the third connection structure 134a.

When the downlight assembly 100a is in the second connection state, the first connection end 111a of the driver assembly 110a is connected to the second connection end 121a of the light source assembly 120a, the light-emitting end 122a of the light source assembly 120a is located inside the through hole 131a of the surface rim assembly 130a and is adjacent to the second light-emitting end 133a of the surface rim assembly 130a, and the second connection structure 124a is connected to the fourth connection structure 135a.

This embodiment provides a modular, reconfigurable downlight assembly 100a, whose core lies in realizing a rapid switch between flat and stepped appearances by toggling between two connection states. The downlight assembly 100a comprises four main parts: the driver assembly 110a, the light source assembly 120a, the surface rim assembly 130a, and the mounting assembly 140a.

The driver assembly 110a may incorporate a constant-current power supply and connect to the light source assembly 120a through the first connection end 111a. The driver assembly 110a and the light source assembly 120a may adopt a quick plug-and-unplug connection, which not only simplifies the installation process but also facilitates later maintenance and replacement. The light source assembly 120a is provided with the second connection end 121a and the light-emitting end 122a at its two ends, and a first connection structure 123a (such as a horn-shaped annular member 1231a) and a second connection structure 124a (such as an elastic snap-fit) on its side wall. This dual-connection-structure design enables the assembly to flexibly adapt to different installation requirements.

The surface rim assembly 130a adopts an innovative design in which a stepped boss 139a is provided inside the through hole 131a. In the first connection state, the third connection structure 134a (such as a spring piece) of the surface rim assembly 130a snap-fits with the first connection structure 123a of the light source assembly 120a to form the first connection state; at this time, the light-emitting end 122a of the light source assembly 120a is flush with the surface rim assembly 130a, forming a flat appearance with uniform light effect suitable for office lighting scenarios. In the second connection state, the fourth connection structure 135a (such as the annular boss 139a) of the surface rim assembly 130a cooperates with the second connection structure 124a of the light source assembly 120a, so that the light source assembly 120a is embedded in the through hole 131a of the surface rim, forming a decorative stepped-drop appearance suitable for residential lighting and anti-glare scenarios. This rapid dual-state switching design allows users to flexibly adjust the appearance of the luminaire according to use scenarios.

The mounting assembly 140a is fixed to the surface rim assembly 130a by the connection lug 142a and cooperates with the connection spring 141a to achieve ceiling suspension. This structural design supports UL-can installation and is also compatible with wooden-board hole installations, greatly improving product applicability. In practical applications, a magnetic interface may be provided on the driver assembly 110a to further simplify docking with the light source assembly 120a; the horn-shaped annular member 1231a of the first connection structure 123a may also adopt a V-type slide-rail design, allowing locking by rotation; and the connection spring 141a of the mounting assembly 140a may be replaced by a magnetic bracket for installation on metal ceilings. These alternative structural designs not only enrich product functionality but also improve manufacturing flexibility.

Embodiments of the present application define two connection states of the downlight assembly 100a—a first connection state and a second connection state—thereby achieving multifunctionality and installation flexibility of the luminaire. In the first connection state, the light source assembly 120a and the surface rim assembly 130a are connected through the first connection structure 123a and the third connection structure 134a to form a flat appearance; in the second connection state, the light source assembly 120a and the surface rim assembly 130a form a stepped appearance through the second connection structure 124a and the fourth connection structure 135a, suitable for anti-glare scenarios and different decoration style requirements. The detachable design between the driver assembly 110a and the light source assembly 120a simplifies maintenance and replacement and reduces maintenance costs. The spring and connection lug 142a design of the mounting assembly 140a further enhances installation adaptability, supporting multiple installation methods such as UL-can installation or wooden-board hole installation. Overall, the solution overcomes the problems of single function and cumbersome installation in traditional luminaires, improving user experience and market competitiveness.

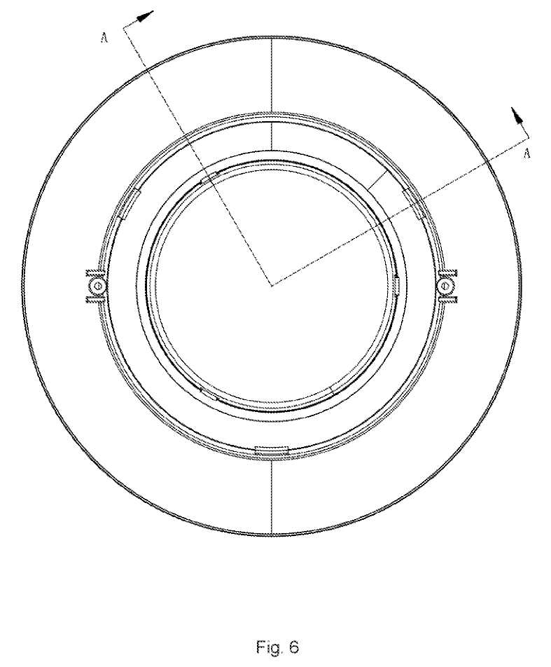

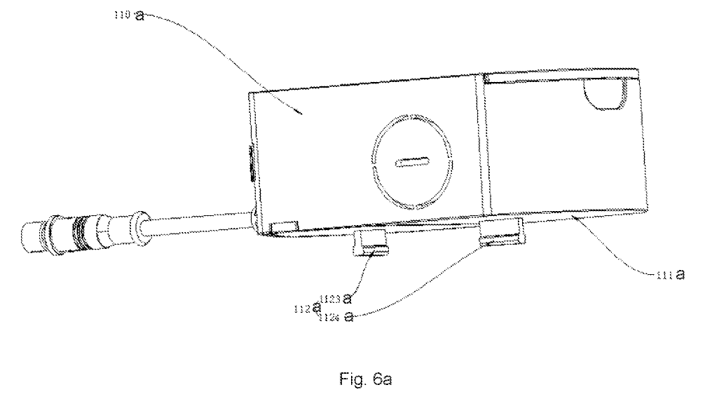

Referring to FIGS. 6a and 7a, FIG. 6a is a structural schematic diagram of a driver assembly 110a in the downlight assembly 100a provided in an embodiment of the present application, and FIG. 7a is a structural schematic diagram of a light source assembly 120a in the downlight assembly 100a provided in an embodiment of the present application.

As shown in FIGS. 6a and 7a, in one embodiment of the present application, the light source assembly 120a is provided with a fifth connection structure 125a, and the driver assembly 110a is provided with a sixth connection structure 112a. The fifth connection structure 125a is detachably connected to the sixth connection structure 112a, and the connection lug 142a is detachably connected to the surface rim assembly 130a. When the downlight assembly 100a is in the first connection state, the first connection structure 123a and the second connection structure 124a are detachably connected. When the downlight assembly 100a is in the second connection state, the third connection structure 134a and the fourth connection structure 135a are detachably connected.

This embodiment provides a modular, reconfigurable, multifunctional integrated luminaire, whose core lies in achieving rapid swapping and multifunctional adaptation through detachable connection structures. The light source assembly 120a is provided with the fifth connection structure 125a, and the driver assembly 110a is correspondingly provided with the sixth connection structure 112a. By detachably connecting the fifth connection structure 125a and the sixth connection structure 112a, the two can be quickly installed and removed without any tools, significantly improving assembly, repair, and replacement efficiency. For example, when the driver assembly 110a requires maintenance, the fifth connection structure 125a and the sixth connection structure 112a can be detached to easily remove the driver assembly 110a without disassembling the entire luminaire, thereby greatly reducing maintenance cost and time.

In the first connection state of the downlight, the first connection structure 123a on the light source assembly 120a tightly engages with the second connection structure 124a of the surface rim assembly 130a, so that the light-transmitting cover and the surface rim are completely flush, forming a smooth flat appearance. In the second connection state, the third connection structure 134a and the fourth connection structure 135a engage to form a distinct stepped drop, which can adapt to different architectural decoration styles while providing an anti-glare effect.

The detachable design between the connection lug 142a and the surface rim assembly 130a allows the mounting assembly 140a to be flexibly replaced to meet the needs of different installation environments. The two can be quickly installed and removed without any external tools, significantly improving maintenance and replacement efficiency.

Referring to FIG. 8a, FIG. 8a is a structural schematic diagram of a surface rim assembly 130a in the downlight assembly 100a provided in an embodiment of the present application. As shown in FIG. 8a, in one embodiment of the present application, the surface rim assembly 130a is provided with a mounting seat 136a, and the mounting seat 136a is provided with a first limiting member 137a and a second limiting member 138a. A limiting space is formed between the first limiting member 137a and the mounting seat 136a. When the connection lug 142a is connected to the surface rim assembly 130a, a portion of the connection lug 142a is located within the limiting space, and the limiting space restricts the connection lug 142a to move only in a first direction. The second limiting member 138a is elastic and, in contact with the connection lug 142a, limits movement of the connection lug 142a in the first direction.

In this embodiment of the present application, the surface rim assembly 130a is provided with the mounting seat 136a, which may be formed by injection molding of high-strength engineering plastics or made of metal to ensure structural strength. Using engineering plastics is also beneficial for maintaining lightweight characteristics. The mounting seat 136a is provided with the first limiting member 137a and the second limiting member 138a. The first limiting member 137a is fixedly connected to the mounting seat 136a, and a limiting space is formed between a portion of the first limiting member 137a and the mounting seat 136a. When assembling the connection lug 142a to the surface rim assembly 130a, the clasping portion at the end of the connection lug 142a can be accurately embedded into the limiting space, and through spatial constraint the connection lug 142a is effectively restricted to move only in the first direction. Allowing the connection lug 142a to move in the first direction is advantageous for achieving disassembly of the connection lug 142a, while restricting movement in other directions ensures that the luminaire will not loosen due to vibration during long-term use. It should be noted that, in this embodiment, the “first direction” may refer to a certain direction in the horizontal direction; for example, the connection lug 142a moves forward and backward relative to the mounting seat 136a in the horizontal direction, and cannot move up and down in the vertical direction or left and right in the horizontal direction.

The second limiting member 138a is an elastic limiting member, for example, it may be made of an elastic metal sheet and fixed to the side of the mounting seat 136a by screws, with its free end having an arcuately curved structure. After the connection lug 142a is assembled in place, the second limiting member 138a contacts the connection lug 142a to restrict the connection lug 142a from moving in the first direction. That is, the second limiting member 138a prevents the connection lug 142a from moving in the first direction, thereby fixing it within the limiting space.

The second limiting member 138a can generate continuous elastic pressure, which both limits displacement of the connection lug 142a in the first direction and provides obvious in-place feedback during installation. This dual-limiting design not only enables quick, tool-free assembly and disassembly but also ensures connection reliability. Compared with traditional screw-fastening installation methods, installation efficiency is greatly improved. When it is necessary to replace different surface rim styles, the connection lug 142a can be easily removed by pressing the release button of the second limiting member 138a, and the entire process requires no tool assistance, greatly simplifying the maintenance procedure. This structure is suitable for lighting venues that require frequent replacement of surface rims, achieving rapid switching of appearance styles through modular design while maintaining stable mechanical connection performance.

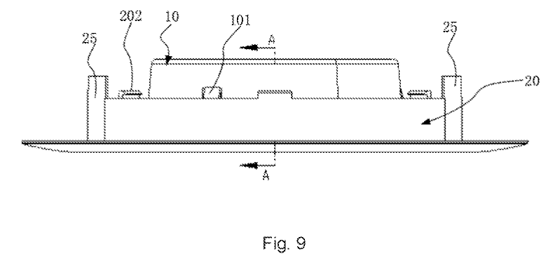

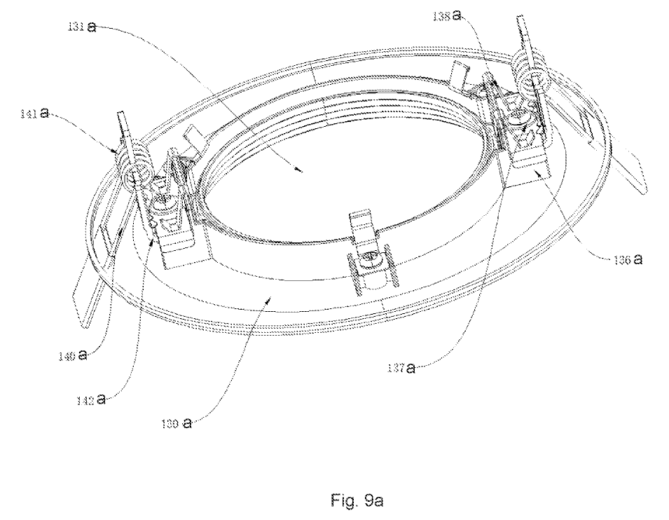

Referring to FIG. 9a, FIG. 9a is a structural schematic diagram of the surface rim assembly 130a and the mounting assembly 140a after cooperation in the downlight assembly 100a provided in an embodiment of the present application. As shown in FIG. 9a, in one embodiment of the present application, the connection lug 142a is provided with a limiting hole 1421a, and the second limiting member 138a is provided with a limiting protrusion 1381a. The limiting protrusion 1381a cooperates with the limiting hole 1421a to restrict the connection lug 142a.

In this embodiment of the present application, the connection lug 142a is provided with the limiting hole 1421a, which may be designed as a circular through hole or an oblong through hole. The second limiting member 138a may be a metal elastic sheet, which can be fixed to the mounting seat 136a by riveting or screws. When the connection lug 142a is pushed into the limiting space along the installation direction, the limiting protrusion 1381a on the second limiting member 138a slides on the connection lug 142a until it automatically snaps into the limiting hole 1421a to achieve locking, at which time a clear “click” sound can be heard, providing in-place assembly feedback. This matching structure forms effective constraints in the X/Y/Z directions, can withstand large pull-off forces, and can be released by applying only a small pulling force on the second limiting member 138a, thereby achieving quick assembly and disassembly.

In practical applications, the limiting hole 1421a may be replaced with a V-groove structure, and the limiting protrusion 1381a may be correspondingly designed as a conical shape to achieve reliable limiting. Alternatively, the limiting protrusion 1381a may be made of magnetic material and cooperate with an iron limiting hole 1421a to achieve non-contact positioning. During installation, the connection lug 142a only needs to be pushed until the limiting protrusion 1381a snaps into the limiting hole 1421a to complete fixation, without tool assistance. Compared with traditional screw fastening methods, this design saves a large amount of installation time and avoids screw loss or stripping issues. When disassembly is required, pressing or pulling the operating portion of the second limiting member 138a with a finger causes elastic deformation, so that the limiting protrusion 1381a disengages from the limiting hole 1421a. The entire process is simple and fast, greatly reducing maintenance difficulty.

As shown in FIGS. 8a and 9a, in one embodiment of the present application, the first limiting member 137a is a washer screw, and the connection lug 142a is provided with a U-shaped slot 1422a. When the connection lug 142a is located in the limiting space, the screw rod of the washer screw is located in the U-shaped slot 1422a.

In this embodiment of the present application, a washer screw is used as the first limiting member 137a. The screw head diameter of the washer screw is larger than that of a conventional screw, forming a clear limiting step surface. The connection lug 142a is provided with the U-shaped slot 1422a, the width of which is slightly larger than the diameter of the washer screw’s screw rod, for example, by 0.2–0.3 mm, to ensure assembly smoothness while avoiding excessive play. When the connection lug 142a is pushed into the limiting space, the U-shaped slot 1422a can accurately fit onto the washer screw rod, and at this time, the limiting step surface of the screw head contacts the surface of the connection lug 142a, effectively restricting displacement of the connection lug 142a in the vertical direction. This design cleverly utilizes existing fasteners to achieve dual functions: on the one hand, ensuring the firm fixation of the mounting seat 136a through threaded connection; on the other hand, achieving quick positioning through cooperation between the screw head and the U-shaped slot 1422a.

During actual assembly, the U-shaped slot 1422a of the connection lug 142a only needs to be aligned with the screw rod and pushed in to achieve accurate positioning within three seconds, significantly improving efficiency compared with traditional installation methods requiring alignment of multiple holes. In some schemes, the washer screw may be replaced with a positioning pin with a flange surface, cooperating with an improved U-shaped slot 1422a to achieve similar limiting effects. Alternatively, a plastic limiting post with an elastic latch may be used, realizing completely tool-free assembly and disassembly while maintaining the limiting function. It should be noted that the opening end of the U-shaped slot 1422a may be designed with a guiding slope of about 15°, which facilitates guiding the screw rod smoothly into the slot under blind assembly conditions. When disassembly is required, the connection lug 142a can be pulled out along the opening direction of the U-shaped slot 1422a without loosening the screw, greatly simplifying the process of replacing the surface rim. This structural design is suitable for track spotlights and other applications requiring frequent adjustment of the luminaire angle, providing great convenience while ensuring connection reliability.

As shown in FIGS. 2a and 8a, in one embodiment of the present application, a stepped boss 139a is provided inside the through hole 131a of the surface rim assembly 130a. The diameter of the stepped boss 139a gradually decreases along the direction from the light emitting end 122a to the second connection end 121a.

In this embodiment of the present application, the through hole 131a of the surface rim assembly 130a is provided with the stepped boss 139a, which may be integrally formed with the surface rim, forming a three-step diameter-reducing structure along the direction from the light emitting end 122a to the second connection end 121a. This gradient design can achieve precise axial positioning of multiple optical components, enabling each part to slide into place sequentially during assembly without additional adjustment, ensuring consistency of the optical central axis. This structure also enhances uniformity of light distribution, ensuring the match between the light output surface and the architectural decoration style. The stepped boss 139a also provides a physical foundation for elastic member connections. In addition, the stepped boss 139a may be replaced with a continuous conical structure, cooperating with an optical component mounting ring having elastic claws, to also achieve precise positioning.

As shown in FIGS. 2a and 6a, in one embodiment of the present application, the first connection structure 123a is a ring member 1231a provided at the light emitting end 122a. The ring member 1231a is trumpet-shaped, with its dimension near the light emitting end 122a smaller than the dimension away from the light emitting end 122a. The third connection structure 134a is a first elastic member 1341a provided on the surface rim assembly 130a. When the first connection structure 123a is connected to the third connection structure 134a, one end of the ring member 1231a away from the light emitting end 122a abuts the third connection end 132a of the surface rim assembly 130a, and the first elastic member 1341a is snapped onto the outer surface of the ring member 1231a.

In this embodiment of the present application, the light emitting end 122a of the light source assembly 120a is provided with the trumpet-shaped ring member 1231a, which may be processed into a structure with a certain cone angle, wherein the inner diameter near the light emitting end 122a is smaller than the outer diameter away from the light emitting end 122a. The corresponding position of the surface rim assembly 130a is provided with the first elastic member 1341a made of a metal sheet, which is in a C-shaped ring structure or V-shaped structure. During assembly, the flared end of the trumpet-shaped ring member 1231a compresses the first elastic member 1341a, causing deformation. As the pushing depth increases, when the end of the ring member 1231a away from the light emitting end 122a passes over the protruding portion of the first elastic member 1341a, the first elastic member 1341a gradually restores elasticity and finally snaps onto the outer surface of the ring member 1231a. At this time, the end of the ring member 1231a tightly abuts the third connection end 132a of the surface rim assembly 130a. This design achieves both axial and radial positioning, completing reliable connection with only a small pressing force. During disassembly, pulling the first elastic member 1341a away from the ring member 1231a can achieve quick separation.

As shown in FIGS. 2a and 8a, in one embodiment of the present application, the first elastic member 1341a includes a first connection portion 1342a and a first snap-fit portion 1343a. The first connection portion 1342a is elastic, and the first snap-fit portion 1343a has a first protrusion 1344a. The first snap-fit portion 1343a is connected to the surface rim assembly 130a through the first connection portion 1342a. When the first elastic member 1341a is connected with the ring member 1231a, the first protrusion 1344a is snapped onto the ring member 1231a.

In this embodiment of the present application, the first elastic member 1341a may be precision stamped from spring steel. Its first connection portion 1342a can be directly fixed to the surface rim assembly 130a by rivets or screws. The first snap-fit portion 1343a is provided with a triangular or V-shaped first protrusion 1344a. The surface of the protrusion 1344a is hardened and provided with anti-slip serrations to ensure the reliability of the connection with the ring member 1231a. By setting the first protrusion 1344a on the first snap-fit portion 1343a, the first protrusion 1344a facilitates better snap-fit with the trumpet-shaped ring member 1231a. It should be noted that, in this embodiment, both the first connection portion 1342a and the first snap-fit portion 1343a can be made of elastic metal sheets to ensure that the entire first elastic member 1341a has good elasticity.

As shown in FIGS. 2a and 7a, in one embodiment of the present application, the second connection structure 124a is a second elastic member 1241a provided on the side of the light source assembly 120a, and the fourth connection structure 135a is an annular boss 139a provided inside the through hole 131a of the surface rim assembly 130a. When the second connection structure 124a is connected to the fourth connection structure 135a, the light source assembly 120a passes through the through hole 131a, the light emitting end 122a of the light source assembly 120a abuts the light-emitting end 133a of the surface rim assembly 130a, and the second elastic member 1241a is snapped onto the annular boss 139a.

In this embodiment of the present application, the side of the light source assembly 120a is provided with the second elastic member 1241a, which is a V-shaped structure fixed in a mounting groove of the light source assembly 120a by welding or riveting. An annular boss 139a is machined inside the through hole 131a of the surface rim assembly 130a. During assembly, the light source assembly 120a is pushed into the through hole 131a, the free end of the second elastic member 1241a slides along the boss 139a and gradually deforms elastically until it passes the highest point of the boss 139a, then quickly rebounds and reliably snaps onto the lower end face of the boss 139a. This connection design allows the assembly process to be completed with a single push action, while disassembly only requires a simple prying of the second elastic member 1241a with a special tool. In some designs, the second elastic member 1241a may also be replaced by a stainless steel torsion spring structure, cooperating with a groove on the boss 139a to achieve multi-point positioning, or a magnetic interlock design may be adopted, with magnets embedded in the annular boss 139a interacting with magnetic conductive plates on the light source assembly 120a. This structure is suitable for scenarios requiring a stepped appearance, achieving a high degree of match between light effects and decorative styles, while avoiding the complexity of installation and maintenance in traditional luminaires.

As shown in FIGS. 2a and 7a, in one embodiment of the present application, the second elastic member 1241a includes a second connection portion 1242a and a second snap-fit portion 1243a. The second connection portion 1242a is elastic, and the second snap-fit portion 1243a has a second protrusion 1244a. The second snap-fit portion 1243a is connected to the light source assembly 120a through the second connection portion 1242a. When the second connection portion 1242a is in a natural state, the second protrusion 1244a protrudes from the circumferential side surface of the light source assembly 120a. When the second connection portion 1242a is in a stressed state, the second snap-fit portion 1243a can move toward the center of the light source assembly 120a, making the second protrusion 1244a flush with the circumferential side surface of the light source assembly 120a.

In this embodiment of the present application, the side of the light source assembly 120a is provided with the second elastic member 1241a structure, which may be integrally formed by stamping high-elastic stainless steel sheets, consisting of the second connection portion 1242a and the second snap-fit portion 1243a. The second connection portion 1242a is an elastic arm structure fixed in the mounting groove of the light source assembly 120a. In its natural state, it allows the second protrusion 1244a of the second snap-fit portion 1243a to protrude outward. The end of the second snap-fit portion 1243a may be designed with a guiding slope to facilitate cooperation with the annular boss 139a of the surface rim assembly 130a.

During assembly, after the second protrusion 1244a contacts the annular boss 139a, the elastic arm deforms elastically, causing the second snap-fit portion 1243a to move toward the center of the light source assembly 120a until the second protrusion 1244a completely retracts to be flush with the circumferential side surface. When the assembly continues to the end of the boss 139a, the elastic arm quickly rebounds, snapping the second protrusion 1244a into a positioning groove of the annular boss 139a, producing a crisp “click” sound as an assembly-in-place prompt. This design significantly improves installation efficiency, allowing the user to complete the operation without tools, while ensuring connection reliability. The elasticity of the second elastic member 1241a also accommodates certain dimensional tolerances, enhancing product compatibility and adaptability.

As shown in FIGS. 2a, 7a, and 8a, in one embodiment of the present application, multiple first elastic members 1341a are provided on the surface rim assembly 130a, distributed circumferentially. Multiple second elastic members 1241a are provided on the light source assembly 120a, also distributed circumferentially.

In this embodiment of the present application, by providing multiple first elastic members 1341a around the circumference of the surface rim assembly 130a, and multiple second elastic members 1241a around the circumference of the light source assembly 120a, the uniformity and stability of the connection are further improved. The multi-elastic member design disperses stress points, avoiding damage caused by stress concentration at a single point, thereby extending the product’s service life. Meanwhile, this layout enhances the concentricity of the light source assembly 120a and the surface rim assembly 130a, ensuring uniform light distribution to meet the requirements of high-end lighting scenarios. The cooperative operation of multiple elastic members also improves vibration resistance, making it suitable for dynamic environments or frequently used applications. The specific number of the first elastic members 1341a and the second elastic members 1241a can be set according to actual needs. Generally, at least three are provided, and they are evenly distributed around the circumference.

As shown in FIG. 4a, in one embodiment of the present application, the fifth connection structure 125a includes a slot 1251a provided at the second connection end 121a and a third elastic member 1252a provided on the light source assembly 120a. The slot 1251a and the third elastic member 1252a are located on opposite sides of the light source assembly 120a. The sixth connection structure 112a includes a rib 1121a and a hook 1122a provided on the driver assembly 110a, disposed on opposite sides of the driver assembly 110a. When the fifth connection structure 125a is connected with the sixth connection structure 112a, the rib 1121a is snapped into the slot 1251a, and the third elastic member 1252a is snapped onto the hook 1122a.

In this embodiment of the present application, the second connection end 121a of the light source assembly 120a is designed with the slot 1251a, which can be formed by direct machining of the metal housing or by integrally molding with plastic. The third elastic member 1252a is fixed in a reserved groove of the light source assembly 120a and protrudes outward. Correspondingly, the driver assembly 110a is designed with the rib 1121a and the hook 1122a, located at opposite positions. During assembly, when the light source assembly 120a is inserted into the driver assembly 110a, the rib 1121a first snaps into the slot 1251a, providing a primary positioning. Then, the third elastic member 1252a slides along the hook 1122a and deforms elastically until it passes the hook, finally rebounding to complete snap-fit. This dual-point engagement ensures stable mechanical connection between the light source assembly 120a and the driver assembly 110a.

In this embodiment of the present application, the third elastic member 1252a may be an L-shaped spring clip with a protrusion end designed to cooperate with the hook 1122a of the driver assembly 110a. The slot 1251a may have a depth greater than the thickness of the rib 1121a, allowing for both positioning and tolerance absorption. By adopting a combination of slot and elastic member, the connection achieves both rigidity and elasticity, ensuring assembly firmness while preventing loosening due to vibration. Additionally, this dual design makes installation and disassembly more intuitive, suitable for scenarios requiring frequent maintenance or replacement.

As shown in FIGS. 2a and 4a, in one embodiment of the present application, the rib 1121a is provided with a tapered guide surface, and the hook 1122a has a guiding slope. During assembly, the rib 1121a enters the slot 1251a along the tapered guide surface, and the third elastic member 1252a moves past the guiding slope to snap onto the hook 1122a.

In this embodiment of the present application, the rib 1121a is designed with a conical or arc-shaped guide surface, reducing assembly resistance and ensuring accurate insertion into the slot 1251a. The hook 1122a has an inclined surface, allowing the third elastic member 1252a to slide smoothly during assembly, reducing material wear. This guiding design makes assembly smoother, reducing the required force and ensuring consistent connection quality across multiple operations. At the same time, it also improves the product’s tolerance range, ensuring stable performance even with slight dimensional deviations in large-scale production.

In one embodiment of the present application, the light source assembly 120a is provided with a plurality of third elastic members 1252a, and the driver assembly 110a is provided with a plurality of hooks 1122a, with each third elastic member 1252a respectively engaged with one hook 1122a.

In this embodiment of the present application, by providing multiple third elastic members 1252a and corresponding multiple hooks 1122a on the driver assembly 110a, the connection between the light source assembly 120a and the driver assembly 110a is strengthened. This multi-point engagement design allows the assembly to evenly distribute stress, avoiding structural instability caused by single-point failure. At the same time, the arrangement of multiple elastic members provides higher resistance to vibration and pulling forces, suitable for complex environments such as outdoor lighting or high-frequency switching applications. The number of elastic members and hooks can be adjusted according to product size and required load-bearing strength, with at least three generally provided and evenly distributed circumferentially.

In one embodiment of the present application, the light source assembly 120a and the surface rim assembly 130a are detachably connected at different positions along the height direction of the light source assembly 120a.

In this embodiment of the present application, the light source assembly 120a is provided with multiple connection structures along the height direction, while the surface rim assembly 130a can select different connection positions to complete assembly. By choosing different connection positions, the relative position of the light-emitting end 122a of the light source assembly 120a and the light-emitting end 133a of the surface rim assembly 130a is adjusted. This relative position change directly affects the beam spread angle and light distribution pattern, enabling flexible adjustment of lighting effects without replacing the light source or surface rim assembly. This structure is particularly suitable for multi-scene lighting requirements, such as indoor environments requiring both accent and ambient lighting.

In one embodiment of the present application, the light source assembly 120a is provided with a plurality of connection structures, and the surface rim assembly 130a is also provided with a plurality of connection structures. Each connection structure of the light source assembly 120a can cooperate with one connection structure of the surface rim assembly 130a.

In this embodiment of the present application, multiple connection structures are arranged on both the light source assembly 120a and the surface rim assembly 130a, providing more assembly options. For example, the light source assembly 120a may have three levels of connection structures, while the surface rim assembly 130a also has three levels of corresponding connection structures. Users can freely select different connection combinations to obtain different light-emitting effects. This multi-level connection design allows a single set of components to achieve multiple lighting modes, reducing the need for redundant products and lowering costs.

In one embodiment of the present application, different assembly positions of the surface rim assembly 130a with the light source assembly 120a correspond to different optical parameters of the lighting apparatus 100a.

In this embodiment of the present application, the change in assembly position not only adjusts the protrusion depth of the surface rim assembly 130a relative to the light source assembly 120a, but also affects optical parameters such as beam angle, luminous flux distribution, and color temperature blending. For example, when the surface rim assembly 130a is connected to the lowest connection position, the distance between the light source and the exit port is the largest, resulting in a smaller beam angle and more concentrated illumination. When the surface rim assembly 130a is connected to the highest connection position, the distance decreases, the beam angle increases, and the light is more diffused. This flexible optical adjustment method provides users with convenient on-site configuration, avoiding reliance on complex optical accessories.

In one embodiment of the present application, different assembly positions of the surface rim assembly 130a with the light source assembly 120a are detected through a sensing structure to distinguish between them.

In this embodiment of the present application, a mechanical or electronic sensing structure is provided at the connection position of the surface rim assembly 130a and the light source assembly 120a, so that when the assembly position changes, the sensing structure can generate corresponding signals. These signals are transmitted to the driver assembly 110a, and the driver circuit sets corresponding working parameters, such as brightness, color temperature, or optical distribution mode, according to the detected assembly position. This sensing-based adjustment mechanism not only increases the intelligence level of the lighting apparatus 100a but also greatly improves operational convenience, allowing users to change optical characteristics by simply reassembling components, without the need for complex operations.

In one embodiment of the present application, the sensing structure comprises an elastic piece located on the surface rim assembly 130a and a trigger point located on the light source assembly 120a. When the elastic piece snaps into the corresponding connection position, it presses the trigger point to generate a configuration signal.

In this embodiment of the present application, the elastic piece may be made of spring steel or elastic plastic and is formed integrally with the surface rim assembly 130a. When the elastic piece presses the trigger point, it generates a mechanical action that is converted into an electrical signal through a micro switch, reed switch, or pressure sensor. This electrical signal is transmitted to the driver assembly 110a, prompting the driver circuit to adjust operating parameters accordingly. This design not only ensures the reliability of signal generation but also improves the safety of the lighting apparatus 100a, as the driver circuit can disable the light source when the elastic piece does not press the trigger point, indicating incomplete engagement.

In one embodiment of the present application, when the sensing structure detects that the surface rim assembly 130a and the light source assembly 120a are not fully engaged, the driver assembly 110a disables the light source to avoid hidden safety hazards caused by incomplete installation.

In this embodiment of the present application, the incomplete engagement state may be caused by assembly errors, material wear, or environmental interference. By setting the driver circuit to prohibit light source operation under incomplete engagement conditions, accidents such as electric shock, overheating, or unstable illumination are prevented. This fail-safe mechanism improves the safety of the lighting apparatus 100a and ensures compliance with relevant safety standards and certifications.

In one embodiment of the present application, the resilient engagement structure between the surface rim assembly 130a and the light source assembly 120a is arranged at multiple angular positions, so that by rotating the surface rim assembly 130a to different angular positions, the corresponding sensing structure generates different configuration signals to adjust different optical parameters.

In this embodiment of the present application, the angular engagement design enables users to adjust the optical performance of the lighting apparatus 100a through simple rotation. For example, rotating 180 degrees may correspond to a different color temperature mode, such as 3000K warm light and 5000K cool light. By using mechanical position recognition or magnetic sensing, the system can accurately identify the angular position of the surface rim assembly 130a and adjust parameters accordingly. This rotational adjustment not only simplifies user operation but also expands the functionality of the same set of components.

In one embodiment of the present application, the light source assembly 120a further comprises an LED module oriented to emit along the height direction, and the housing is provided with a cylindrical body and a horn-shaped expansion portion.

In this embodiment of the present application, the LED module emits light along the height direction to match the central opening of the surface rim assembly 130a, ensuring efficient optical transmission. The cylindrical body provides structural stability, while the horn-shaped expansion portion optimizes light distribution, making the light more uniform and reducing glare. This structural design enables the lighting apparatus 100a to provide both aesthetic appeal and functional performance, meeting the needs of modern architectural lighting.

In one embodiment of the present application, fastening brackets are further disposed on the side of the housing of the light source assembly 120a, and each fastening bracket is provided with a buckle engagement structure that cooperates with the housing to achieve detachable assembly.

In this embodiment of the present application, the fastening brackets allow the lighting apparatus 100a to be directly fixed onto building structures such as ceilings or walls. The buckle engagement structure enables quick installation and removal, reducing construction time and labor costs. By combining resilient engagement of the surface rim assembly 130a and buckle engagement of the fastening brackets, the entire system achieves modular assembly, facilitating both mass production and field installation.

The above embodiments of the present application disclose a lighting apparatus capable of flexible assembly. By setting multiple resilient engagement structures along the height direction of the light source assembly, detachable connection of the surface rim assembly at different positions is realized, thereby adjusting the relative position of the light-emitting opening and achieving different optical parameters. At the same time, by combining sensing structures, buckle engagement of the driver assembly, and fastening brackets, a lighting apparatus is achieved that is safe, reliable, flexible, and easy to install, effectively overcoming the limitations of traditional structures.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a light source module including a housing that defines a height direction and contains at least one light source;
a plurality of resilient engagement structures disposed on the housing, wherein the plurality of resilient engagement structures are positioned at different locations along the height direction; and
a surface rim having a central opening and a surrounding rim, wherein the central opening is configured for transmission of light from the at least one light source, wherein the surrounding rim is configured to conceal an installation cavity, and wherein the surface rim is detachably secured to the housing by engagement with a selected one of the plurality of resilient engagement structures so as to configure the lighting apparatus with different structural or optical parameters.

2. The lighting apparatus of claim 1, wherein the resilient engagement structures comprise resilient snap-fit members.

3. The lighting apparatus of claim 1, wherein the resilient engagement structures are disposed at multiple levels along the height direction of the housing.

4. The lighting apparatus of claim 1, wherein the surface rim comprises a resilient engagement portion configured to snap-fit with a corresponding one of the resilient engagement structures.

5. The lighting apparatus of claim 1, wherein engagement of the surface rim with different ones of the resilient engagement structures adjusts at least one of a protrusion depth of the surface rim relative to the housing, a visible aperture size of the central opening, and a concealment depth of the installation cavity.

6. The lighting apparatus of claim 1, wherein a plurality of different surface rims are interchangeably attachable to the housing at different ones of the resilient engagement structures.

7. The lighting apparatus of claim 1, wherein engagement of the surface rim with different ones of the resilient engagement structures causes a distance between the at least one light source and the central opening to vary.

8. The lighting apparatus of claim 7, wherein variation of the distance alters a beam spread angle of light emitted from the lighting apparatus.

9. The lighting apparatus of claim 1, wherein the surface rim engages a first one of the resilient engagement structures when the light source module is installed in a downward direction relative to the surface rim, and engages a second one of the resilient engagement structures when the light source module is installed in an upward direction relative to the surface rim.

10. The lighting apparatus of claim 1, further comprising a driver circuit electrically coupled to the at least one light source and disposed within the housing.

11. The lighting apparatus of claim 10, further comprising a driver box coupled to an upper cover of the light source module by a buckle engagement structure.

12. The lighting apparatus of claim 11, wherein the buckle engagement structure comprises a groove formed in one of the driver box and the upper cover of the light source module and a resilient tab formed on the other, the resilient tab being configured to resiliently engage the groove.

13. The lighting apparatus of claim 12, wherein the buckle engagement structure comprises two grooves and two tongues, with the two grooves for inserting the two tongues separately.

14. The lighting apparatus of claim 13, wherein in a first configuration the tongue and the resilient tab are disposed on the driver box and the two grooves are disposed on the upper cover of the light source module, and in a second configuration the tongue and the resilient tab are disposed on the upper cover of the light source module and the two grooves are disposed on the driver box.

15. The lighting apparatus of claim 1, further comprising a plurality of sensing structures respectively associated with the resilient engagement structures, wherein engagement of the surface rim with a selected one of the resilient engagement structures actuates a corresponding one of the sensing structures to generate a configuration signal indicative of a selected engagement position, and wherein the driver circuit is configured to set an operating parameter of the lighting apparatus based on the configuration signal.

16. The lighting apparatus of claim 15, wherein a resilient member of the surface rim depresses the corresponding one of the sensing structures upon completion of snap-fit engagement to generate the configuration signal.

17. The lighting apparatus of claim 15, wherein when the configuration signal indicates incomplete engagement of the surface rim with the selected one of the resilient engagement structures, the driver circuit disables the at least one light source.

18. The lighting apparatus of claim 15, wherein the resilient engagement structures define a plurality of angular engagement positions at different rotational orientations and the sensing structures are arranged to distinguish the plurality of angular engagement positions, and wherein the driver circuit is configured to set different optical parameters based on a detected rotational orientation.

19. The lighting apparatus of claim 1, wherein a plurality of fastening brackets are disposed on a side portion of the lighting apparatus, and wherein each fastening bracket is configured with a buckle engagement structure to detachably couple with the housing of the light source module.

20. The lighting apparatus of claim 1, wherein the light source module comprises an LED module oriented to emit along the height direction and comprises a cylindrical body and a flared horn-shaped extension surrounding the LED module.
